(19) United States
(12) Patent Application Publication
(10) Pub. No.: US 2020/0357080 A1
(43) Pub. Date: Nov. 12, 2020

(54) SYSTEM AND METHOD FOR DETERMINING INFLUENCE OF CHANNELS IN A SOCIAL NETWORK

(71) Applicant: Reveal Systems, Inc., Sherman Oaks, CA (US)

(72) Inventors: Erik T. Bogaard, Pasadena, CA (US); Jason F. Fairchild, Rolling Hills Estates, CA (US); Sean M. Kirkpatrick, Chesterfield, NJ (US)

(21) Appl. No.: 16/869,390

(22) Filed: May 7, 2020

Related U.S. Application Data
(60) Provisional application No. 62/844,460, filed on May 7, 2019.

(51) Int. Cl. G06Q 50/00; G06Q 20/40; G06Q 30/02; G06F 21/62

(52) U.S. Cl. CPC G06Q 50/01; G06F 21/6245; G06Q 30/0208; G06Q 20/40145

(57) ABSTRACT

A social media service and platform generates an improved measure of influence based on measures of purchases of fans made in response to content appearing on an influencer's channel. The improved influence score addresses the problem that conventional influence scores are often unreliable due to the use of bots and other techniques to artificially increase the number of fans and likes of an influencer's channel. Additional measures to ensure integrity of channels and support privacy and security may also be supported by the social network service.

### CROSS-REFERENCE TO RELATED APPLICATIONS

This application claims priority to U.S. Provisional Application Ser. No. 62/844,460, filed May 7, 2019, which is hereby incorporated herein in its entirety by this reference.

### TECHNICAL FIELD

Embodiments of the disclosure are generally related to determining influence of an influencer in a social network.

### BACKGROUND

Social media systems provide opportunities for people to become influencers who create content viewed by a community of fans. Some examples of social media networks include YouTube®, Instagram®, and Facebook®. Examples of the content that influencers can post include postings of text, images, audio clips, video clips, etc.

Influencers often specialize. As one example, influencers can create educational channels. For example, some popular yoga teachers have channels in which they provide fans with daily inspirational messages, tips for doing yoga poses, advice on meditation, and advice on nutrition. Some popular chefs have channels in which they provide fans with recipes, cooking advices, photos of food, video cooking clips, and reviews of restaurants. There are outdoor channels in which influencers post content about different types of hunting, fishing, camping, and backpacking options, adventures, and equipment.

Influencers can also create image or lifestyle channels as other examples. For example, some actors and entertainers have channels in which they create content centered about their daily life.

There are social media channels in a wide variety of categories. Many of these channels are largely non-commercial. Some also promote non-profits or charitable causes. For example, some cancer survivors have created content in which they create inspirational content to encourage other cancer survivors, support cancer research, and so on.

The number of fans that an influencer has may vary widely. For example, some life coaches have less than 100 fans. Some famous life coaches have millions of fans.

Social media systems provide only a few limited analytical tools for providing information about the relationship between influencers and fans. As a result, it can be difficult in some cases for an influencer to determine to what extent they are influencing the behavior of fans. For example, a lifestyle coach with a million fans may be considered a powerful influencer based on total number of fans, and yet have no quantitative idea how much their posts influence the daily decisions of fans.

Influencers who are content creators also face a number of problems related to how social media platforms accept ads. Most influencers have too few fans to directly negotiate with marketers to provide agreed on marketed content. As a result, most influencers have no control of the type of ads displayed to their fans. The ads that are displayed to fans of the influencer's channel may be incongruent and even contrary to the content created by the influencer. That is, the ads may be inconsistent with the image, advice, content, and social message of the influencer.

There are a variety of other problems in social media related to how influence is measured. One problem is that conventional techniques to determine influence can be manipulated. For example, there are bot services in which it is possible to purchase “users,” “likes,” “comments,” and even “shares.”

This creates a variety of issues in social media. One of these is that it leads to a form of image distortion. For example, which source of news is more credible and has more integrity—a social media channel with 100,000 fans or a social media channel with 1,000,000 fans?

Let's consider a hypothetical example of two French chefs, Pierre and Jean Paul. Pierre is the real deal, a French chef who has 100,000 devoted fans of modern French cooking. Pierre throws his heart and soul into the art of cooking, engaging with fans because of his passion for cooking and his belief that good cooking and long slow meals bring people together. In contrast, suppose Jean Paul is something of a faker, in that he looks handsome in a chef's outfit, but is a second-rate cook who never mastered the intricacies of real French cooking. Suppose Jean Paul uses a service that has bots that have wildly inflated his number of fans to 150,000, even though his number of true human fans is 50,000. Additionally, Jean Paul may even hire other people to write his posts for him, making him appear to be far more eloquent and knowledgeable than he really is.

In this example, there are several problems in terms of image distortion regarding the value and integrity of their respective brands. When Pierre goes to a book agent and tries to publish a book on the essence of modern French cooking, he may be turned down in favor of a book by Jean Paul because Jean Paul has a larger number of social media fans that appear to be more engaged because of Jean Paul's use of bots. Similarly, when Pierre goes to the local television network and proposes doing a cooking show, he may be turned down in favor of Jean Paul because Jean Paul has more social media fans, more likes, more shares, and more daily postings.

In effect, Pierre is punished for not using bots to inflate his fan count. Pierre is also punished for not hiring other people to write posts for him. To add insult to injury, Pierre has basically no control over the ads displayed to fans on his channel. Very few influencers in social media make a lot of money from ads alone. But ads, such as YouTube® ads, often help to defray operating costs such that most influencers accept ads on their channels. However, social media ad systems often select ads based on things like the demographics of the fan. The ads that may be displayed to a particular fan viewing Pierre's channel may be incongruent with Pierre's social message. The ads could be anything, including ads for American fast food. In the conventional social media paradigm, Pierre basically has no practical way to negotiate with individual advertisers to control the types of ads on his channel. The time and cost to negotiate such deals would typically be prohibitive for all but a few world-famous chefs.

The way social media works tends to create a form of marginalization of passionate creators in favor of second-rate hacks who game the system. This is just one example of marginalization. The same thing happens in many niches in social media. In effect, real influencers (aka “Tastemakers”) engaging with real fans creating real value are marginalized by bots driving manufactured activity to create false measures of influence in terms of total number of fans, likes, shares, and so forth. And the practice of hiring others to write posts also marginalizes passionate creators. And then on top of that, it has been impractical for most influencers to control the ads displayed on their channels. This creates problems for influencers to control their image while using ads to pay a portion of their operating expenses.

### SUMMARY

In some implementations, a social media service and platform generates an improved measure of influence based on measures of purchases of fans made in response to content appearing on an influencer's social media channel. The content may include one or more posts made in response to a payment transaction of the influencer, where a payment transaction may a purchase of a good or service, a charity donation, or a donation to a non-profit. The improved influence score addresses a problem that conventional influence scores are often unreliable due to the use of bots and other techniques to artificially increase the number of fans and likes of an influencer's channel.

Additional measures to increase integrity of social media channels and support privacy and security may also be supported by the social network service. In some implementations, fans and influencers are issued payment instruments to aid in tracking purchases. In other implementations, inferences about an influencer's purchases are made using other types of information, such as information posted on an influencer's social media channel.

The influence score may be used to generate incentives to foster a healthy social media community. In some implementations the influence score is use to apportion incentives by providers of good and services.

### BRIEF DESCRIPTION OF THE DRAWINGS

FIGS. 1A and 1B illustrate examples of a social media service that generates improved influence scores in accordance with implementations of this disclosure.

FIG. 1C illustrates an example of a platform architecture in accordance with an implementation.

FIGS. 1D, 1E, and 1F are examples of interaction diagrams in accordance with some implementations.

FIG. 2 is a flowchart of a method in accordance with an implementation.

FIG. 3 is a flowchart of a method in accordance with an implementation.

FIG. 4 is a flowchart of a method in accordance with an implementation.

FIG. 5 is a flowchart of a method in accordance with an implementation.

FIG. 6 is a flowchart in accordance with an implementation.

FIGS. 7, 8, 9, and 10 illustrate examples of a user interface in accordance with some implementations.

FIG. 11 illustrates an example of platform registration and payment instrument generation in accordance with some implementations.

FIG. 12 illustrates an example of aspects related to tracking an influencer's purchase in accordance with some implementations.

FIG. 13 illustrates an example of tracking a fan's payment transaction and matching it to an influencer's payment transaction.

FIG. 14 illustrates an example of generating offers and coupons in accordance with some implementations.

FIG. 15 illustrates an example interaction diagram in accordance with some implementations.

### DETAILED DESCRIPTION

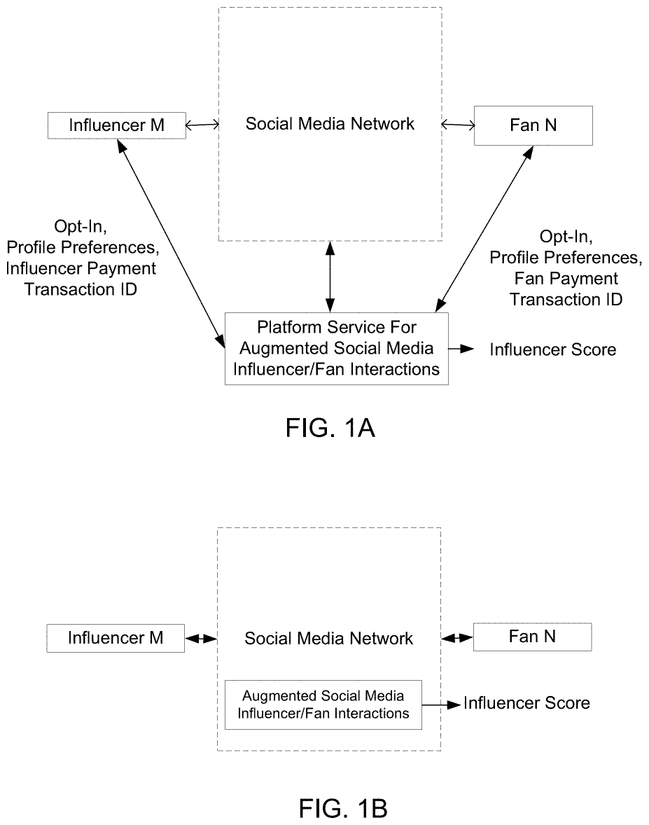

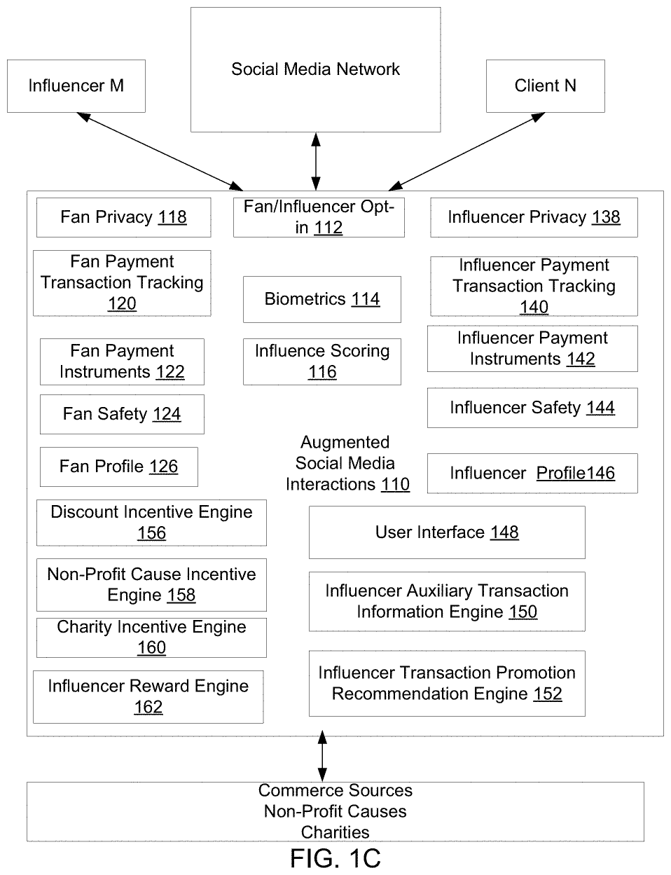

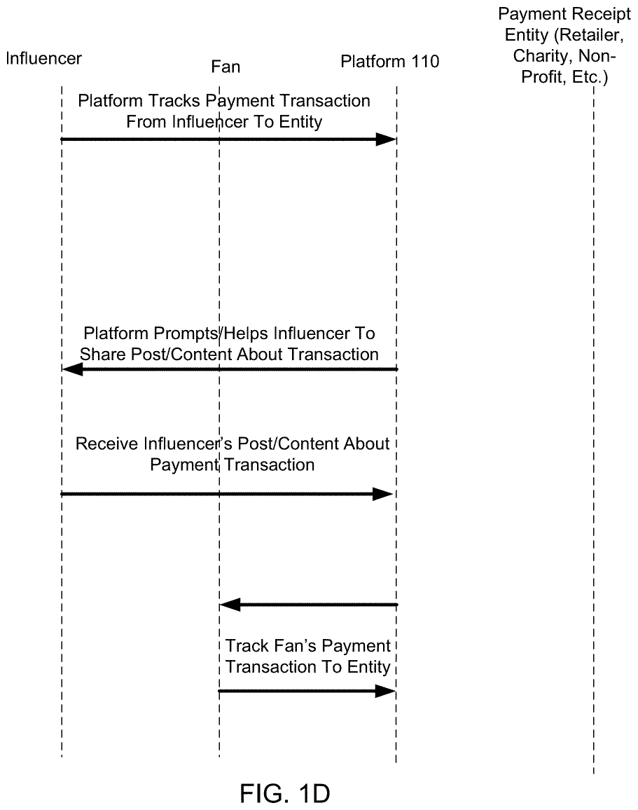

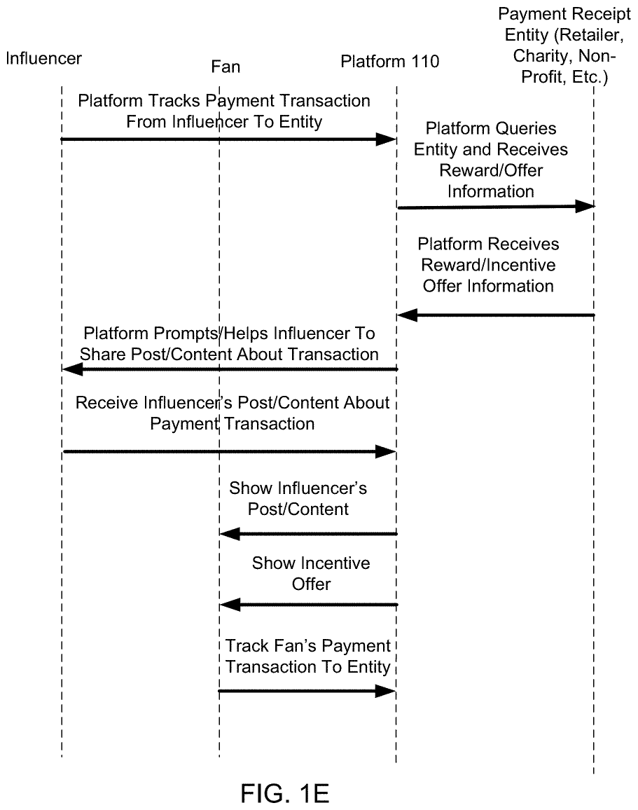

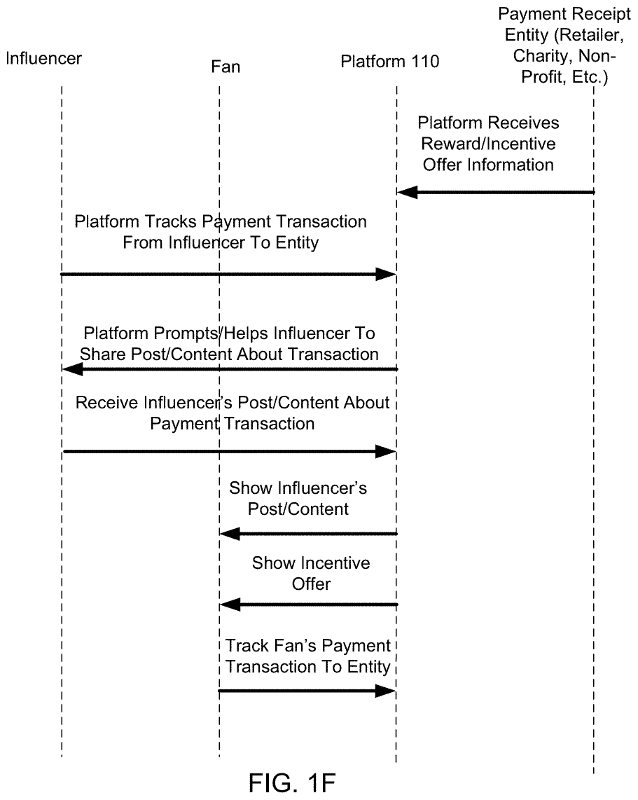

FIGS. 1A and 1B are high level diagrams illustrating how a social media network may be augmented to include additional social media influencer and fan interactions. In FIG. 1A, a platform service provides augmented services to a social media network. As an example, a downloadable portion of the platform service could be downloaded to a user's client computer or browser. The platform service may also be implemented as a cloud-based service or network service. That is, the platform service may provide an intermediary service that monitors the social media interactions of clients acting in the role of influencers and fans. The platform service may also interact with the social media network through social media network APIs. In the example of FIG. 1A, users (as influencers or fans), register with the platform service through an opt-in procedure that may include entering profile preferences.

In some implementations, each influencer is provided with an influencer payment instrument registered to the influencer such that there is effectively a transaction tracking ID to track a payment made by the payment instrument. Each fan may be provided with a fan payment instrument registered to individual fans and having a tracking ID. These transaction IDs may correspond to a payment transaction ID such as a payment instrument card number (e.g., a card number of a credit card or a debit card), a payment ID (e.g., a mobile payment ID of a smartphone), although other options are also possible. For example, the transaction ID could be implemented as a “club ID” used at the time of purchase.

Fans may be provided with a variety of financial or non-financial incentives to opt-in. Examples of financial incentives include discounts and coupons. Examples of non-financial incentives include access to special content prepared by the influencer, special information on the private tastes and preferences of the influencer, opportunities to participate and contribute to charities or social causes of the influencer, or other benefits. As illustrated in FIG. 1B, the augmented services could also be integrated within a social media system.

As illustrated in FIGS. 1A and 1B, the use of influencer transaction IDs and fan transaction IDs permits to generate one or more influence scores in a way that considers how the actions and postings of an influencer affects payment transactions of fans.

FIG. 1C is a block diagram illustrating in more detail an example of a platform 110 having computer code instructions to implement augmented social media interactions. In some implementations, one or more features are included to minimize the impact of bots. For example, the fan/influencer opt-in module 112 may include a captcha test at the time of opt-in to distinguish robot interactions from human interactions. Other options include two-step authentication at the time of opt-in as another example. More generally, it will be understood that other features to minimize the impact of bot may be included, such as detecting patterns of behavior consistent with bots (e.g., fans entering comments, likes, and shares in ways that are inconsistent with normal human behavior).

In some implementations, platform 110 supports biometric authentication of the influencer to prevent the influencer from hiring others to post in their name. In some implementations, biometric authentication of the influencer may also be supported by a biometric authentication module 114. An example of biometric authentication includes performing a face scan of influencer, an eye scan, or a fingerprint scan. For example, the camera on an influencer's smart phone or computer may take a picture of the influencer's face. For example, biometric authentication may be performed when the influencer logs into their account, when the influencer posts content (e.g., a payment transaction, photo, or status update), when making a purchase of a product or service using the influence tracking ID, interacting with platform posts (e.g., liking or coming on fan posts). The biometric authentication may be part of a larger security and authentication profile.

In some implementations the fan would be notified that authentication measures were being used. For example, fans could be notified on a portion of the channel that states that the posts of the influencer were biometrically authenticated. The fans could also be provided a listing, such as a page, showing purchases made by the influencer that are authenticated to have been made by the influencer (e.g., using the influencer's transaction ID). This option provides a way for fans to feel closer to influencer because they can trust that they are interacting with the influencer and learning what products and services an influencer actually uses. That is, biometric scanning may be used to increase the actual and perceived integrity of an influencer's channel to fans.

An influencer score module 116 generates one or more influence scores, which are described below in more details and which take into account payment transactions made by the influencer and payment transactions made by fans influenced by the influencer. Payments may be for goods or services, but more generally may include payments to charities, payments to non-profit causes, and so on. For example, an influencer may make a payment to purchase a good or service, such as purchasing an item of clothing or a meal at a restaurant. But an influencer may also want to share a donation to a charity (e.g., a donation to feed hungry homeless people) or to a non-profit (e.g., a donation to a college scholarship fund, a donation to an open space preserve, etc.). The influencer's payment transactions may be communicated to fans in the form of content posted on the influencer's channel, but more generally a page could be automatically created on the influencer channel to summarize payment transactions and associated content. For example an influencer who is a chef could post content mentioning cooking supplies the chef bought. Alternatively, a summary of purchases made by the chef could be created on a separate page for fans of the chef.

A variety of modules and engines may be provided to support the augmented social media interactions. An influencer privacy module 138 may be included to support secure communication with the influencer, secure storage of confidential information, etc. Options may also be provided for a level of privacy. For example, if the influencer payment instrument 142 is a credit card or other payment card, then maintaining some details confidential may be more important for some influencers than others, depending on the influencers image and their personal concerns for privacy. For example, while an influencer who is a Hollywood star may not have image problems sharing a night out at a bar, an influencer in a more conservative profession that frowns on drinking (e.g., an accountant) may want privacy protection to ensure that payments for certain classes of goods and services will never be shared with others.

Influencer transaction tracking 140 tracks payment transactions of an influencer. A primary way it does this is by the use of an influencer payment instrument 142, which may be a payment card, payment code, or payment identifier. More generally the influencer payment instrument could function like a club card that is used in conjunction with a conventional credit card or payment card. A notification is generated each time an influencer uses an influencer payment instrument. This notification is provided to the influencer transaction tracking module 140. However, the influencer transaction tracking module may also use other forms of information. This may include location tracking information from an influencer's smart phone (with authorization of the influencer) and information derived from the influencer's channel, such as by analyzing the influencer's content for indications of new clothing, new accessories, descriptions of events and purchases, etc. For example, a machine learning system could be trained to analyze the content of an influencer's channel and identify events likely to correspond to a payment transaction, such as the appearance of new clothes on an influencer in a picture or video or a description of buying new clothes.

An influencer safety module 144 may implement one or more safety protocols. For example, some Hollywood celebrities have levels of fame in which stalking of the celebrity is a potential concern. In a few rare cases, deranged fans have killed celebrities, such as in the example of the murder of famed singer John Lennon. Thus, in some implementations, an influencer can select one or more safety features. A delayed posting feature is an example of this. For example, a celebrity's posting of visiting a particular restaurant may be delayed until after they have left. This could be implemented, for example, by including an option for a fixed or variable delay for one or more types of payment transactions. Alternatively, the post could be delayed until the influencer has moved away a selected minimum distance from the location of the payment transaction (e.g., as determined by a smartphone's location tracking data). In some implementations, some details of a post may be obfuscated. For example, obfuscation of the driver's license plate of a celebrity's car is an example. Obfuscation of other pieces of personal information in photos is possible, for example, using a machine learning system trained to identify common security risks and pixelate or otherwise obfuscate details in postings that may pose one or more potential security risks. Such safety considerations may be less important for some influencers than others. Such safety considerations may be less important in some locations and times than others. For example, a Hollywood celebrity may have a personal bodyguard for big celebrity events but lack the protection of a personal bodyguard when doing their day-to-day activities, such as ordinary shopping, eating at restaurants, etc.

An influencer profile module 146 may store profile information for an influencer. This may include, for example, general profile information and also a profile of their posting behavior, interaction with fans, payment transactions, etc. That is, platform 110 is actively monitoring the content posted by the influencer and generating a profile of the influencer based at least in part on that data.

In some implementations, fans have similar modules to address similar issues. For example, a celebrity can be a fan of other influencers, and thus be extremely concerned about privacy and safety. In some implementations, a fan privacy module 138 may be included to support secure communication with the fan, secure storage of confidential information, etc. Options may also be provided for a level of privacy. For example, if the fan payment instrument 122 is a credit card or other payment card, then maintaining some payment details confidential may be more important for some fans than others. For example, some fans may be quite comfortable sharing, on a fan page, that they purchased items similar to the influencer. For example, some fans may be quite happy that a fan page shares such information. But more generally, some fans may want to select a level of security about what details of their purchasing behavior influenced by an influencer is kept confidential. For example, in many online communities, it may be essential to keep the details of purchases made by fans in strict confidence in order to preserve a sense of trust. However, in other communities, some fans may be willing and even eagerly interested in sharing details of purchases inspired by an influencer. For example, some social media communities centered around Hollywood celebrities have fans who want to imitate the lifestyle of a celebrity influencer and who might want to know how many other fans are imitating the celebrity's purchases.

Fan transaction tracking module 120 tracks payment transactions of a fan. A primary way it does this is by the use of a fan payment instrument 142, which may be a payment card, payment code, or payment identifier. More generally, the payment instrument could function like a club card that is used in conjunction with a conventional credit card or payment card. A notification is generated each time a fan uses a fan payment instrument. This notification is provided to the fan transaction tracking module 140. However, a transaction tracking module may also use other forms of information. This may include location tracking information from the fan's smart phone (with authorization of the fan) and information derived from the fan's postings on the influencer's channel (and optionally from the fan's postings on other channels). For example, a machine learning system could be trained to analyze the content posted by a fan and identify events likely to correspond to a payment transaction, such as the appearance of new clothes on a fan in a picture or video or a description of buying new clothes.

A fan safety module 144 may implement one or more safety protocols. For example, fans may also desire that it be difficult for others to track their location. For example, some parents worry that their children can be tracked and kidnapped. Thus, for example, consider a child acting in the role of a fan of a child celebrity or the fan of a channel that posts toy reviews. A concerned parent may want safety features to make it difficult for third parties to determine the exact current location of their child. Thus, if a child-influencer has a toy review channel and posts about buying a toy at a particular toy store, other fan children may go to the same toy store and buy the same toy. But then this poses a potential safety concern if these child-fans have smartphones and post about their purchase. Thus, safety options may also be provided for fans, such as including an option for a fixed or variable delay for one or more types of payment transactions. Alternatively, the post could be delayed until the fan has moved away a selected minimum distance from the location of the payment transaction (e.g., as determined by a smartphone's location tracking data). In some implementations, some details of a post may be obfuscated for safety considerations.

A fan profile module 146 may store profile information for each fan. This may include, for example, general profile information and also a profile of their posting behavior, interaction with influencers and other fans, payment transactions, etc. That is, platform 110 is actively monitoring the interactions of an influencer's content feed with fans and generating a profile of each fan based at least in part on that data. In some implementations, the platform 110 may also monitor the fan's postings on other channels.

Let's return now to the influencer scoring module 116. It has a wider variety of data available to in that in conventional influence scoring. As a consequence, the influence scores it generates are more reliable indicators of influence in terms of the ability of an influencer to influence their fans to purchase goods, purchase services, make donations to charity, or make contributions to non-profit causes. This can also be further refined into a variety of very specific influence scores for ability to influence fans to purchase particular classes of goods, services, charitable contributions to particular types of charities, and donations to particular types of non-profits.

The influence score may be a weighted score or a set of different weighted scores. The weighted score is based on different factors. In some implementations, at least one of the factors is based on determining payments for goods, services, charitable causes, or non-profit causes inspired in fans by actions of the influencer. For example, a multi-factor scoring may consider factors such as the number of views, interactions, behavioral actions on the part of fans (e.g., making a purchase of a good or service; contributing to a charity or non-profit), and promoting an action taken by the fan in response to an influencer (e.g., a fan purchasing an item that the influencer purchased and the fan further going on to share a post of the fan's purchase).

A multi-factor weighted scoring may have the weights empirically varied. As an example, in some implementations, the multi-factor scoring may heavily weight the actions of fans in terms of imitating the purchases/contributions made by the influencer and posting about such imitation. As a non-limiting example, an influence score to define a scale to measure influence could weight data collected from fan interactions with influencer content (e.g., posts) as follows:
Data collected from Fan Interaction with Influencer Content (e.g., Post)
   # of Views—weighted 10%
      (# of followers who viewed/# of total followers)
   Interact (Like 2%/Comment 3%/Share 5%/Wish 15%)—weighted 25%
      (# of viewers who [like, comment, share, wish]/# of aggregate platform users)
   Act (actually make purchase as tracked by system)—weighted 50%
      (# of viewers who actually purchase/# of aggregate platform users who purchase)
   Promote (share post purchase)—15%
      (# of purchasers who actually share/# of aggregate platform users who share)

The percentages in the above example are mere illustrative and can be varied and include additional factors. For example, statistical techniques or machine learning techniques could be used to determine weights that are predictive of how influential a factor is in a general sense of inspiring fans to make similar payment decisions as the influencer. However, this can be further specialized based on specific classes of goods, services, charities, or non-profits. For example, it could be that fans of a cooking channel are likely to buy cooking equipment described by a chef-influencer. That type of influence may be different than the chef's influence when the chef posts about a great meal the chef had at a restaurant. And the chef's ability to influence fans in regards to the chef's contribution to a non-profit “foodie” charity fundraiser may also be different. And the chef's influence may also be different in regards to the influence of the chef on the fans when the chef makes a donation for scholarships to a cooking academy.

Note that fan engagement can be determined based on a weighted average in some implementation. For example, engagement could be determined from: Actual measured conversion (for given Influencer)/total measured conversion (across entire system). However, other forms of weighted average may be used as a metric of fan engagement.

In principle, there may be multiple influence scores generated for each category of channel. Some examples of categories include food, fashion, and athletics. The category may, for example, be selected by an influencer from a set of categories during a profile set-up process. For example, each individual influencer may have an influencer score by category in addition to a general influencer score. For example, Tiger Woods would be ranked high in “Golf” category but perhaps lower than Mario Batali in “Cooking” category.

The influence scoring module 116 may include many different factors in generating an influence score. One example is including a factor calculating score which includes interactions by other recognized Influencers with a given Influencer's post. Another example of a factor is to include other measured Influencer's Views, Interactions, Acts, Promotes (as defined above) of given Influencer's post. As another example, brand interactions with a given Influencer's post may be used. A factor may include measured Brand Views, Interactions and Promotes (as defined above) of given Influencer's post. A factor may include a platform user's mentions of given Influencer's name. The mentions may be of a given Influencer's name within the social network platform 110 and/or outside of said social network platform 110 (e.g., in one or more ordinary social media networks). Other examples of factors include mentions by other Influencers, by Fan users, by Brand users (charities, businesses, advertisers).

Note that more than one influence score may be generated. For example, the factors may be varied and their weighting adjusted to give a set of different influence scores that provide a more comprehensive understanding of influence than a single influence score. It depends on what aspects of influence are relevant. Also it depends on what types of interactions we are interested in monitoring and incentivizing.

For example, suppose Influencer A has 1,000,000 fans. This is not a huge number of fans by the standards of social media. However, suppose that Influencer A has 10 M measured influenced purchases. If the influence scoring module 116 gives a lot of weight to actual purchases inspired by Influencer A, Influencer A is extremely influential in influencing purchases by their fans. Suppose now that Influencer B has say 1,000 fans. Thus, if Influencer A mentions or shares Influencer B's content, this could be extremely valuable in ways not reflected using conventional concept of influence.

In some implementations, tiered tracking is supported. In tiered tracking, the interactions of two or more influencers are considered. For example, suppose influencer A has a small following. For example, suppose influencer A is a gourmet who loves posting about food and wine but only has a small following, say 1,000 fans. Influencer A may visit a new restaurant, purchase a meal using the influencer payment instrument, and share his visit with his 1,000 followers. Suppose one of these fans was an influencer with a much greater number of fans. For example, suppose Influencer B is a world-famous celebrity who has 30 million fans. Suppose Influencer B shares the post with their fans or otherwise shares the information they learned from influencer A about the new restaurant. In an example of tiered influence tracking, then the platform 110 tracks the sharing of the post by Influencer A (as a first influencer) and tracks how many fans of influencer B are influenced to visit the new restaurant.

The concept of tiered tracking can be extended to track all influencers in “tracked chain” of influence. For example, there could be Influencer A in Los Angeles, who is gourmet with 1,000 follower. One of Influencer A's fans may be a local celebrity (Influencer B) in Los Angeles with 100,000 followers. However, that Influencer B may, in turn, have a fan who has 10,000,000 followers (Influencer C).

This form of tiered tracking and determining tiered influence can be used in different ways. For example, in Hollywood there are personal trainers who specialize in training Hollywood celebrities. As a result the true influence of this group of personal trainers in terms of their diet and exercise advice is far greater than might be expected from the number of their fans because the fans they have sometimes include huge followings. Thus, if a personal trainer in Hollywood buys a new vitamin supplement or a new piece of workout equipment, there is a potential for one of their postings about that to reach huge numbers of people through their fans sharing or reposting the information, given that some of their fans include world-famous Hollywood stars.

Tiered tracking may be used in different ways to recognize influencers in a chain of influence. This may include, for example, identifying chains of influence and dividing an incentive reward up to give a portion of the incentive to influencers in a chain of influence. For example, suppose gourmet A, with a small following of 1,000 fans post about a great meal at a local restaurant and one of these 1,000 fans in a celebrity influencer (Influencer B) with 1,000,000 fans. Influencer B then goes to the same restaurant and posts about their meal. Let's say business doubles at the restaurant over the following month after Influencer B posts about their meal at the restaurant. All of the rewards could be given to Influencer B. Alternatively, the concept of tiered influence could be used to give a portion of the reward to Influencer A. Tracking tiers of influence permits, for example, generating rewards by influencer reward engine 162 that incentivize influencers with small numbers of fans to post about goods and services they have purchased.

This concept of tiered influence can be used to calculate an influence score.

The influence score (or scores) may be used in a variety of ways. Influencers benefit from influencer scores in a variety of ways. For example, consider the example of a gourmet chef who has a small following in terms of number of fans. However, the gourmet chef may have a high influence score in terms of purchases made by fans. And the gourmet chef may have a high influence score in terms of tiered influence if some of their fans have large followings. Such information may be useful for the gourmet chef in contexts outside of social media, such as in convincing a conventional book publisher to publish the chef's cookbook.

The influence score may be used by third parties to make decisions about interactions with the influencer and their fans. For example, the influence score (or scores) may be provided to advertisers to make decisions to display ads to fans of an influencer. The influence score (or scores) and profile information on the channel category may, for example, be used by advertisers to select ads.

The influence score (or scores) may also be used in a variety of other ways. One possible application is to use the influence score to determine how to split rewards between influencers. For example, in the case of a tiered chain of influence, one possibility is to use the influence scores of each influencer in a chain of influence to help determine how to split up incentives/rewards generated by influencer reward engine 162.

Another possibility is to use the influence score of an influencer to determine how to divided up a reward when a fan has two or more influencers. For example, consider the case where a fan has two influencer who are each fitness coaches. Influencer A posts about a new vitamin supplement they purchased. The fan read this post. Sometime later, the same fan views a post from Influencer B about Influencer B's purchase of the same vitamin supplement. It is after viewing this later posting by Influencer B that the fan purchases the same vitamin supplement. In this case, it may be that it is reading posts by both Influencers for the same good or service that led to the fan making a purchasing decision. While all of the reward could be given to Influencer B, alternatively the reward could be split so that a portion of the reward could also be given to Influencer A. One way to do that would be to weight the reward given to Influencer A and Influencer B by their respective influence scores.

An influencer auxiliary transaction information engine 150 may be provided to generate information about the influencer's payment transactions, such as generating lists of recent transactions for the influencer or for fans.

User interface module 148 supports generating user interface for fans and for influencers.

In some implementations, an influencer transaction promotion recommendation engine 152 automatically identifies purchases made by an influencer based on an output of the influencer tracking module 140. In response it generates a recommendation to post content related to the payment transaction. For example, it may generate a listing of recent payment transactions and prompt the influencer to write one or more posts. An influencer auxiliary transaction information may also be included to identify, from influencer tracking module 140, likely transactions and make suggestions to the influencer to post content for possible payment transactions.

An influencer reward engine 162 may be included to determine a reward for the influencer when content describing a payment transaction influences fans to make a similar payment transaction. For example, if an influencer eats at a restaurant and posts about it, they may be given a reward calculated by how many of their fans eat at the same restaurant. In some implementations, the number of fans is verified by data from fan tracking module 120.

In some implementations, incentives are provided for fans to imitate the payment transactions of influencers. A discount incentive engine 156 may, for example, generate discount coupons or discount codes when a fan reviews content of a payment transaction of an influencer. Similarly, a charity incentive engine 160 and a non-profit cause incentive engine 158 may be provided. For example, a fan could be alerted to an incentive to donate, such as a limited time period for a matching donation to be made, recognition on a donor's list, or an offer of a gift for a donation exceeding a given amount.

For example, an API may be provided for commerce sources, non-profit causes, and charities to agree to their participation and provide details to populate the discount engine 156, non-profit cause engine 158, charity incentive engine 160, and influencer reward engine 162. As an illustrative but non-limiting example, suppose an influencer makes a payment transaction, such as eating at a local restaurant and posting about it. If there is no previous information about that particular restaurant stored, the API may be used to query the restaurant, request participation in the reward program, and provide options for the restaurant to provide a discount to the influencer's fans. Of course, in many circumstances a company, non-profit, or charity that knows of the existence of the platform 110 could sign up with the platform 110 and provide such details in advance.

In any case, the platform 110 uses information on payment transaction to determine an entity associated with the transaction. The platform 110 has fan profile information, influencer profile information, information on the payment transactions of the influencer and of fans, influence scores, and other information, as described above. This provides a lot of information from which an entity could determine a reward to the influencer or incentives for fans. For example, this information could be used by the platform 110 or by an entity to determine a fair economic value to reward the influencer in regards to generating incentives.

The platform 110 effectively democratizes social media in the sense that it empowers individuals of all backgrounds to control image and monetize actual measured influence without requiring pre-negotiated, upfront relationships with advertisers/brands/etc. which are currently unattainable but for the select few ‘celebrities.’ It empowers artists to self-align with brands/restaurants/retailers/charities/organizations without first reaching out directly. It gives creative people, such as artists, an ability to self-align without upfront, negotiated agreements. It also helps organizations realize which artists/Influencers are fond of them. For example, the platform empowers brands/restaurants/retailers/charities/organizations to proactively identify (through the platform) which artists/Influencers (based upon tracked purchase history, engaged fan data, etc.) are best fits for an individual brand.

FIGS. 1D, 1E, and 1F illustrate examples of interaction diagrams. FIG. 1D illustrates a sequence of interactions. In FIG. 1D, the platform tracks a payment transaction from an influencer to an entity. As examples, this could be an online payment transaction or a payment transaction made at a retail establishment. For example, an online payment platform could be used that uses an ID associated with the payment instrument of the influencer to provide the transaction information to the platform. If the payment instrument is a credit card, the transaction information may be reported by the credit card entity or otherwise monitored by the platform. If the payment instrument is mobile phone payment system, this may also be reported or monitored by the platform. The platform prompts or otherwise helps the influencer to share a post or content about the transaction. The platform receives or otherwise intercepts the influencer's post or content about the payment transaction. The platform tracks one or more fan's payment transaction to the same entity. This can include, for example, providing a coupon, discount, or other trackable incentive for the fan as one option. As other options, the platform can verify that the fan viewed the post/content by the influencer, track payment by the fan to the payment receipt entity through the fan payment instrument (e.g., a credit card, club card, ID/code, mobile phone payment app, etc.), and make an inference that the fan's payment was influenced by the payment transaction of the influencer.

FIGS. 1E and 1F illustrate examples for implementing incentives. In FIG. 1E, the platform dynamically queries a payment receipt entity after learning about a payment transaction. This can include querying about incentives/rewards for the influencer and incentives for the fans. That is, the platform 110 includes an algorithm to effectively negotiate or otherwise reach agreement on a reasonable set of incentives. For example, the platform could suggest to a retailer a common discount for fans (e.g., 5%, 10%, or some other common discount) and a reasonable incentive/reward for the influencer. In FIG. 1E, the platform also shows fans the agreed upon incentive offer. FIG. 1F deals with the somewhat different situation that a payment receipt entity provides reward and incentive offer information in advance.

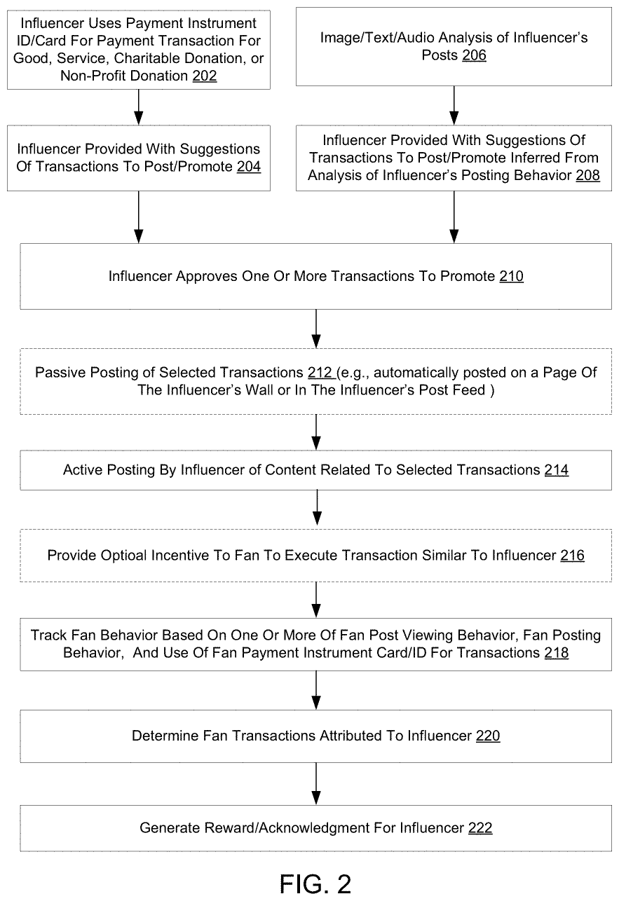

FIG. 2 is a flowchart of a method in accordance with an implementation. In block 210, an influencer approves one or more suggested transactions to post content about or otherwise promote. As illustrated in FIG. 2, the influencer may be provided with suggestions of transactions to post content about or promote based on the influencer's use of the payment instrument to make a payment transaction as illustrated in blocks 202 and 204. Alternatively, or in combination, the influencer is provided with suggestions of transactions to post content about or otherwise promote inferred from an analysis of a influencer's posting behavior and any associated location information. For example, if the influencer posts a photo in their social media channel showing them wearing a new brand shirt or sunglasses, the platform can make an inference based on image analysis. Other data, such as location data (if available) may also be considered, along with a textual analysis of content. For example, an influencer might pay in cash for new sunglasses, post a picture of themselves with the sunglasses, post that they love their new sunglasses, and so on.

In block 212, the approved transaction may be passively posted on the behalf of the influencer. For example, a page of the influencer's channel may list recent items purchased by the influencer, charitable donations, or donations to non-profits. Alternatively, a separate UI page may summarize such information for fans. This passive posting may be provided as an option or as a mandatory feature, depending on implementation details.

In block 214, there is active posting by the influencer of content related to a selected approved transaction. That is, the influencer creates content for fans based around the transaction. This could be facilitated, for example, through a user interface to help an influencer quickly create text and/or tag photos or videos related to the transaction.

In block 216, an optional incentive is provided to a fan to execute a transaction similar or identical to the influencer. For example, a fan could be provided with a discount to a restaurant the influencer ate at and posted about. For the case of a charity, an incentive for making a donation might be an offer of a matching donation by a third party, a listing in a list of donors, a small honorary gift, etc.

In block 218, the fan behavior is tracked. This can include tracking their viewing behavior of the post, any incentive, the fan's posting behavior (e.g., comments, likes, or other postings related to the influencer's post about the transactions), and the use of a fan payment instrument to make a payment transaction.

In block 220, a determination is made of fan transactions attributed to the influencer's posting of content/promotion related to a payment transaction of the influencer.

In block 222, a reward or acknowledgement is generated for the influencer based on the fan transactions attributed to the influencer. The reward could be financial in terms of a cash reward. For influencers with small fan numbers it could be a discount or coupon. For example, an influencer who is a yoga teacher with a very small but devoted following of several hundred yoga students might be rewarded for posting to her fans about her favorite vegetarian restaurant by receiving coupons for free dinners at the vegetarian restaurant. For a charity or non-profit, the reward could be an honorary award or recognition at a fund raising dinner, an honorary gift, a certificate of appreciation, etc.

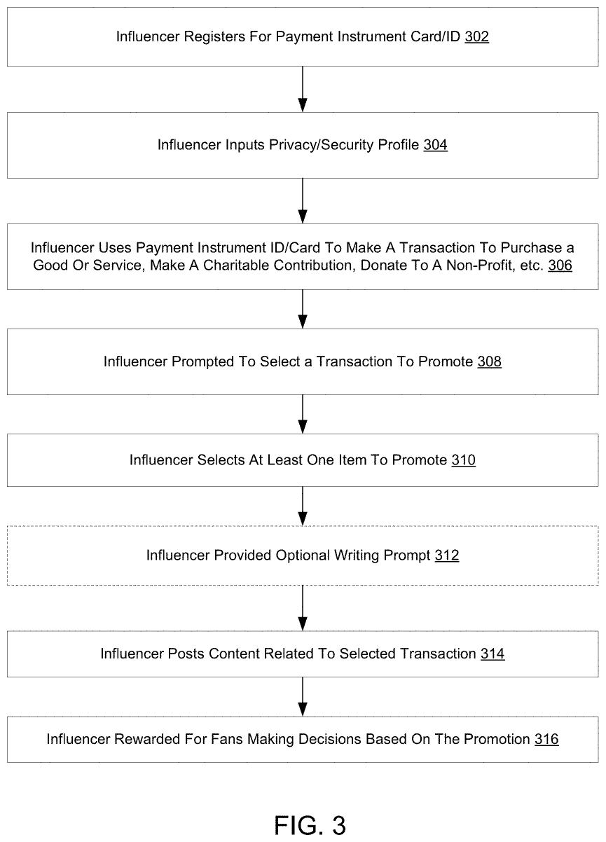

FIG. 3 is a flowchart of a method in accordance with some implementations to reflect an example of an influencer's perspective. In block 302, an influencer registers for a payment instrument. Again, this may be implemented as a credit card, bank card, club card, payment ID, payment code, smartphone payment system, or through other means used to make and track payments.

In block 304, the influencers input a privacy and security profile after opting into use of the platform.

In block 306, the influencer used the payment instrument to purchase a good, service, or make a donation. This results in a payment transaction.

In block 308, the influencer is prompted to select a transaction to promote.

In block 310, the influencer selects at least one item to promote. For example, some transactions correspond to a single item. However, in many cases a single transaction, such as a purchase transaction at a fashion boutique, may correspond to several items (e.g., purchase of a dress and a matching handbag at a boutique).

In block 312, the influencer is provided with an optional writing prompt. For example, a user interface may include features to make it easy for an influencer to tag photos with information about a payment transaction (e.g., tagging purchases in a photo), and make a content suggestion, (e.g., “Did you enjoy your lunch at Pierre's bistro? Write an upbeat post about your experience!”). Intelligent features could also be included based on machine learning techniques. For example, an intelligent chatbot could be trained using machine learning techniques to generate a writing prompt or otherwise aid an influencer to quickly create content about a selected item. For example, suppose an influencer bought a designer dress from a boutique. The user interface could provide a writing prompt to help the influencer know whether it is the boutique or the brand name, or both that should be mentioned in the content. Other examples include providing a prompt on the address, location, proper name, or other details. For example, suppose an influencer was an absent-minded professor. Perhaps the absent-minded professor forgets small details like the exact name of a retail establishment and its location. The user interface could provide writing prompts or writing aids to help the absent-minded professor write content that is accurate regarding specific details related to a payment transaction and items associated with the payment transaction.

In block 314, the influencer posts content related to the selected transaction and the selected item(s).

In block 316, the influencer is reward for fans making decision based on items and transactions that the influencer promoted.

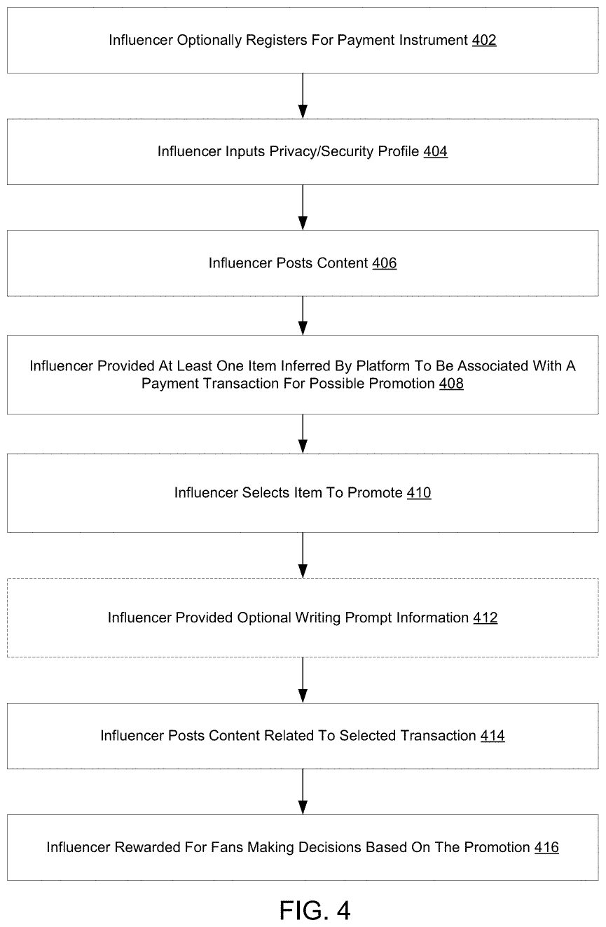

FIG. 4 deals with the situation, from the point of view of an influencer, in which the platform infers payment transactions. For example, the platform may use image analysis and use machine learning techniques to analyze an influencer's channel. The platform may optionally request and receive authorization to obtain other information about a user, such as smartphone location data, vehicle tracking data etc.

For some famous celebrities, there are many sources of news that can be mined to make inferences about payment transactions. Other social media channels and news sources could also be mined, as well as other sources of public information. For example, in some states, it is possible to lookup driver's registration data based on license number and/or name. Thus, image analysis of photos of a car in an influencer's feed or in other news sources might suggest they bought a new car. Other types of purchases might be inferred from things like brand labels or logos on designer clothes worn in photos. For example, some charities and non-profits publish lists of donors.

In FIG. 4, an influencer optionally registers for a payment instrument in block 402.

In block 404, the influencer opts-in and inputs a privacy and security profile. This may include, for example, authorizing the platform to mine content in the channel. It may also include authorization to use other forms of information, such as smartphone location data, vehicle location data, and other sources of private or commercial data.

In block 406, an influencer posts content.

In block 408, the influencer is provided with at least one item, inferred by a platform to be association with a payment transaction, for a possible promotion. As previously discussed, this inference could be based solely on the content within the influencer's channel but could more generally include other sources of information consistent with the privacy expectations agreed upon with the influencer.

In block 410, an influencer selects an item to promote.

In block 412, the influencer is provided with optional writing prompt information. This may, for example, include user interface prompts or guidance to aid the influencer.

In block 414, the influencer posts content related to the selected transaction.

In block 416, the influencer is rewarded for fans making decisions based on the promotion.

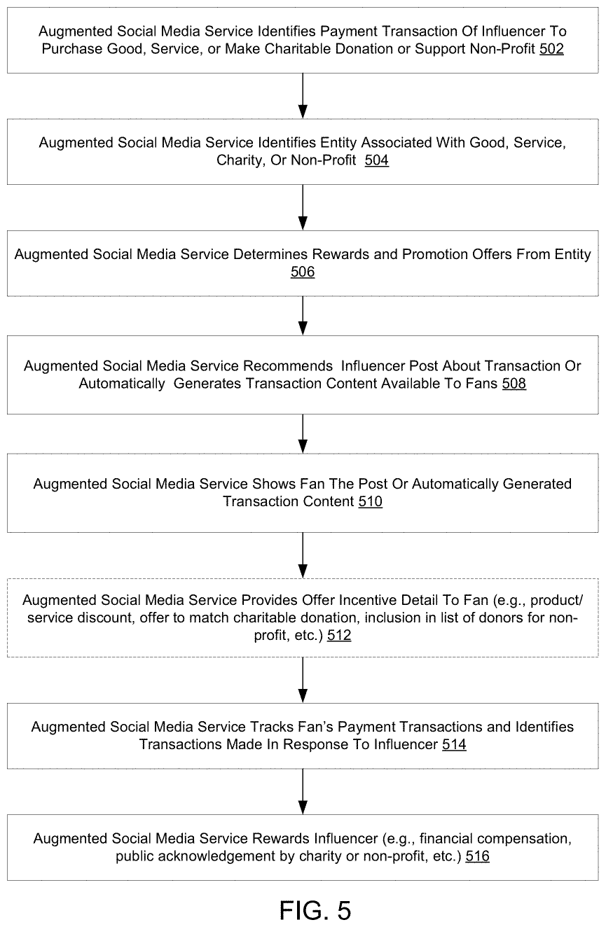

FIG. 5 illustrates an example of a flowchart from the perspective of actions taken by the platform implementing an augmented social media service in some implementations. In block 502, an augmented social media service identifies payment transactions of the influencer. In block 504, the service may further identify the entity associated with the payment transaction. This may be, for example, a retail establishment associated with the payment transaction. But it may also be a particular product or product brand as a few examples.

In block 506, the service determines rewards and promotion offers from the identified entity. This may be implemented dynamically. Alternatively, in some cases it may be done ahead of time by individual entities registering with the platform.

In block 508, the service recommends the influencer post content about the transaction or alternatively generates automatically generated content, such as on a listing of purchases or donations made by an influencer.

In block 510, the service, shows the fan the post or automatically generated content about the payment transaction.

In block 512, the service may provide an incentive offer to a fan.

In block 514, the service tracks the fan's payment transactions and identifies transaction made in response to viewing the influencer's channel.

In block 516, the service directly or indirectly rewards the influencer.

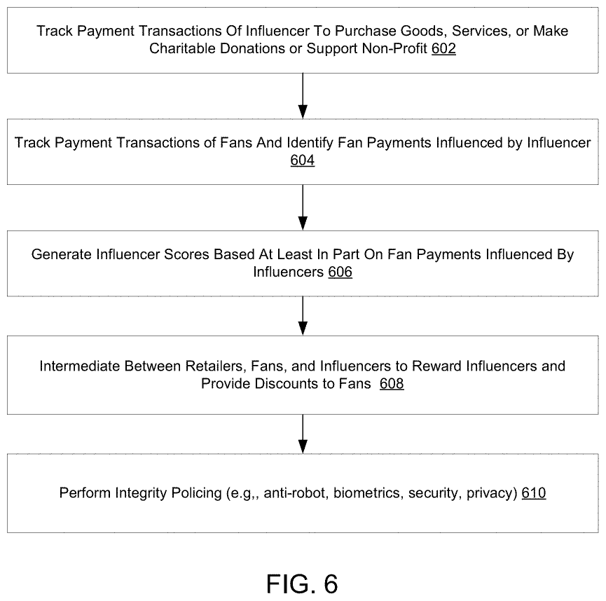

FIG. 6 is a flowchart illustrating an example of generating influence scores and policing integrity. In block 602, the platform tracks payment transactions made by the influencer. In block 604, the platform tracks payment transaction by fans. In block 606, the platform generates influencer scores based at least in part on fan payments influence by influencers. In block 608, the platform intermediates between retailers, fans, and influencers to reward influencers and provide discounts or other incentives to fans. This aspect is important for community building, in that both influencers and fans can benefit. Also, by serving as an intermediary, the platform eliminates the need for an influencer to negotiate with a retailer. Retailers also benefit in terms of having access to fans likely to buy similar goods or services as the influencer. For example, in some implementations, the influencer score may be provided to retailers.

In block 610, integrity policing is performed. This can include, for example, biometrics to ensure the influencer is actively involved. Another option is anti-bot measures, such as Captcha for fans. More generally, other forms of integrity policing may be performed by the platform. That is, the platform can take one or more measures to help foster the healthy development of channels by tastemakers.

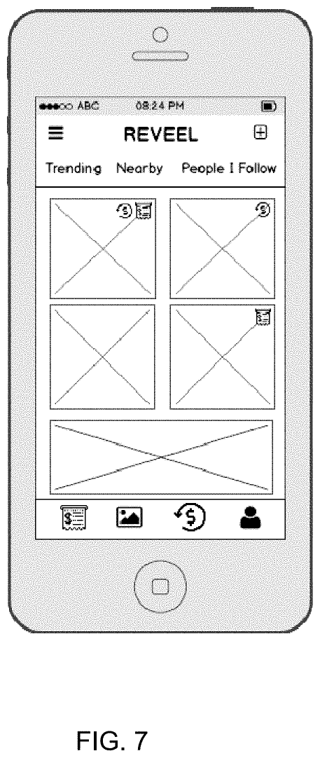

FIG. 7 illustrates an example of a wireframe of a smartphone user interface (UI). As illustrated in FIG. 7, the UI may include icons to help a fan follow channels of influencers, access coupons/discounts, and aid a fan to obtain information to make payment transactions similar to an influencer.

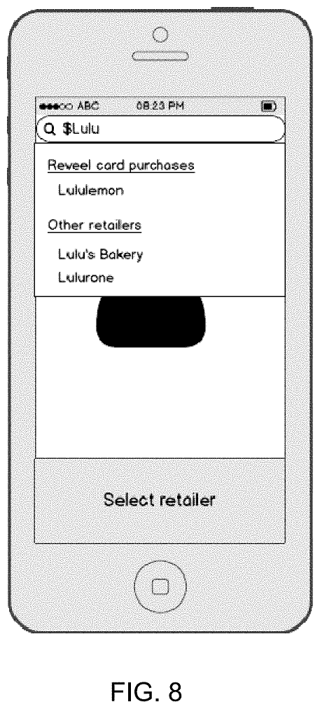

FIG. 8 illustrates how the user interface may show a list of payment transactions made by an influencer. This may, for example, be generated to aid an influencer in creating content about their payment transactions. Alternatively, in some implementations, a fan may also be provided with access to a page listing the payment transactions by an influencer. In this example, the payment transactions were made by a “Reveel” card.

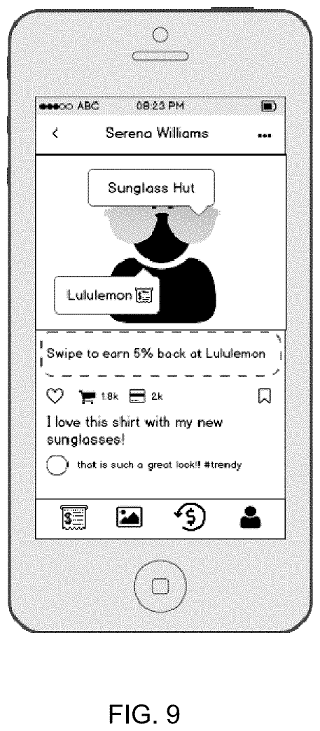

FIG. 9 is a mockup of how a UI might appear to a fan of a celebrity (e.g., Serena Williams). In this example, the celebrity posts a photo of themselves with new clothes. Additional fields may be provided to label or tag clothing items and accessories in the photo. In this example, the celebrity has posted about the new clothes and accessories. A fan can see the posting. A coupon (e.g., a discount) is also displayed for the fan as an incentive to buy the same products as the celebrity.

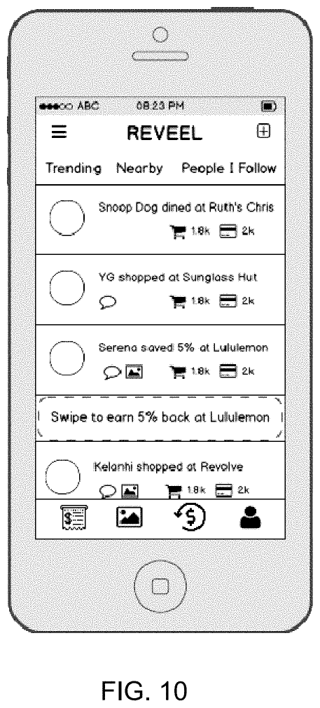

FIG. 10 illustrates an example of a UI page summarizing recent purchases made by a user's influencers and any discounts. FIG. 10 also illustrates an example in which an influencer receives a discount. For an influencer with a large number of fans, a discount by itself may not be a significant incentive to post. However, for an influencer with a modest number of fans (e.g., 1000 fans), a discount may be a more significant incentive to participate.

FIGS. 7-10 illustrate how a UI can make the augmented social media interactions easy and convenient for influencers and fans to use. From the influencer's perspective, the UI can provide aid to generating posts related to payment transactions. From the fan's perspective, information is readily available on payment transactions made by the influencer. The fan may also benefit from discounts and coupons.

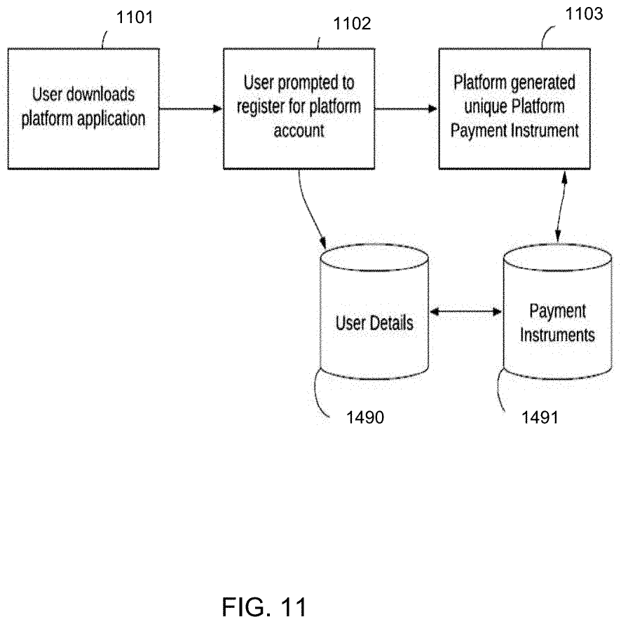

FIGS. 11-15 illustrate additional examples. FIG. 11 depicts a high-level logic function 101 for an exemplary platform from a User's perspective of registration for an exemplary embodiment of a system of the present invention. In some implementations, an exemplary User would download an application (such as, for example, a mobile application developed using Apple™ iOS) onto a user's device to register to participate in the exemplary platform (which may sometimes be referred to generally as “Influencer Commerce”).

As will be understood by someone with ordinary skill in the art, an exemplary User (such as, for example, an exemplary Influencer, exemplary Fan, Influencer, Fan, Influencer User or Fan User) would use an exemplary User device to participate in an exemplary platform of the present invention. In one embodiment of the present invention, a User would use a User device to register, view a social feed (such as, for example, a collection of “Posts” which will be understood by someone with ordinary skill in the art to be a piece of content published online), view prior purchase history, manage Fan Users, and otherwise interact more broadly with the exemplary platform. In one exemplary embodiment, an exemplary User would use a personal smart phone (such as, for example, an Apple™ iPhone) to register and participate with the exemplary platform. In some embodiments, an exemplary User would not download an application onto a User's device but instead use the Internet to communicate with the exemplary platform through a User's device. Reference herein to a mobile application or the Internet is illustrative and is not a limitation of the present invention. As will be understood by someone with ordinary skill in the art, any connected computer device able to communicate with the exemplary platform whether now known or in the future discovered could be used to access and use exemplary platform without departing from the spirit of the present invention.

In one exemplary embodiment as depicted in exemplary function 1102 in FIG. 11, an exemplary User would complete a registration process to participate in exemplary platform “Influencer Commerce”. Advanced computer programmed instructions would be operably installed on exemplary User device instructing User device to facilitate User registration.

In one exemplary embodiment, a registration process would include asking a User for personal and/or financial information, including but not limited to first name, last name, personal address, business address, email, phone number, credit card details, debit card details, personal bank account details, business bank account details or information otherwise needed to complete enrollment in the exemplary program. Reference herein to specific registration data elements as defined previously are illustrative and is not a limitation of the present invention. Rather, in some exemplary embodiments, an exemplary User would be asked for social security number (whether entire or partial) and/or birth date as a part of the registration process.

Continuing in reference to FIG. 11, in one exemplary embodiment detailed in exemplary function 1103, once a User has registered, the exemplary platform would generate a unique Platform Payment Instrument for a User to participate in exemplary platform and to attempt and complete purchase transactions. As further explained below, a User would use an exemplary Platform Payment Instrument to participate in the exemplary platform.

As will be understood by someone with ordinary skill in the art, a Platform Payment Instrument may be a virtual card or physical card, such as a debit, credit or pre-paid card issued by a traditional card network such as Mastercard™, Visa™, Discover™ or American Express™. In some exemplary embodiments, an exemplary Platform Payment Instrument may be a unique number understood by the exemplary platform and not include a card—whether physical or virtual—at all. As will be understood by someone with ordinary skill in the art, there could be other ways, without departing from the spirit of the present invention, for exemplary embodiments to generate a Platform Payment Instrument. For example, a Platform Payment Instrument could be a barcode, QR code, PIN, or random hash string.

In one exemplary embodiment, once generated by the exemplary platform, the exemplary Platform Payment Instrument would be shared with an exemplary User. As will be understood by someone with ordinary skill in the art, an exemplary Platform Payment Instrument could be shared with an exemplary User in a variety of ways such as directly through a mobile application (such as, for example, an Apple™ iOS mobile application) or a website provided by exemplary platform. In other exemplary embodiments, the exemplary Platform Payment Instrument may be shared with an exemplary User directly through another channel of communication now known, such as email, short message service, multimedia messaging service, facsimile, or traditional mail (such as through the USPS™, FedEx™ or UPS™), or a channel of communication discovered in the future without departing from the spirit of the present invention.

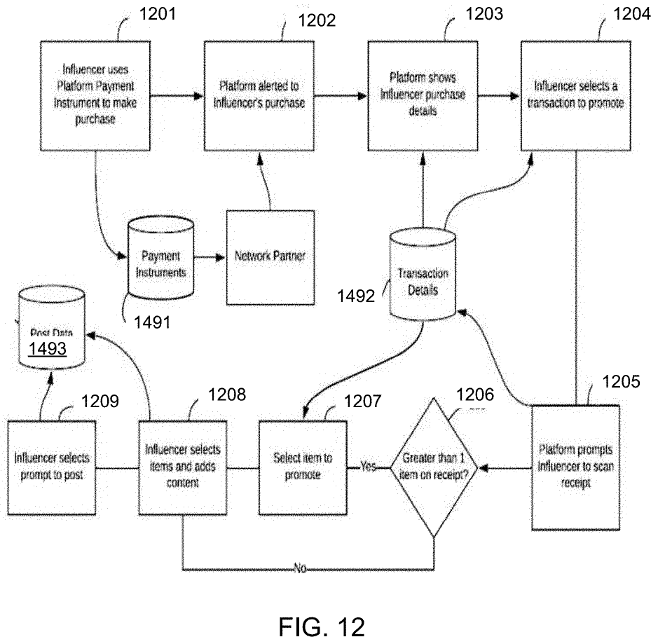

FIG. 12 depicts high-level logic functions for tracking an Influencer User's transaction activity and data in order to track and confirm Influencer-Influenced-Fan-Purchases in an exemplary embodiment of the present invention. In one exemplary embodiment, an Influencer is a User who has shared a Post (defined in more detail below) using the exemplary platform.

In one exemplary embodiment, advanced computer programmed instructions would be operably installed on an exemplary User device instructing the User device to track the exemplary Influencer User's transaction activity, transaction data and User data in order to confirm Influencer-Influenced-Fan-Purchases.

In one exemplary embodiment, continuing in reference to FIG. 12 exemplary function 1201, an Influencer would use a pre-paid payment card issued by the exemplary platform herein referred to as the “InCard” to attempt and complete a purchase transaction. In one exemplary embodiment, an Influencer would use the exemplary InCard to make a purchase at a participating retailer. In one exemplary embodiment, the InCard would be a co-branded card between the exemplary platform and a known payment network (such as, for example, MasterCard™). In one exemplary embodiment, a participating merchant would include any merchant participant in the Mastercard™ network, any merchant participant in the exemplary platform network or any merchant participant in both Mastercard™ and the exemplary platform network.

As will be understood by someone with ordinary skill in the art, the use of a pre-paid card is illustrative and is not intended to be limiting. Rather, in some exemplary embodiments, instead of using a pre-paid card, an Influencer could use a debit card, credit card, direct ACH payment, cryptocurrency payment, PAYPAL™ account, or any other electronic payment whether now known or in the future discovered that was either provided by the exemplary platform to an Influencer to be used by the Influencer to participate in the exemplary platform or provided by the Influencer to the exemplary platform to be used by the Influencer to participate in the exemplary platform. In one exemplary embodiment, an Influencer may provide one's own payment instrument (such as, for example, a personal debit card, business credit card, or bank account details) to the exemplary platform during the registration process. In one exemplary embodiment, an Influencer-provided own payment instrument would be saved by the exemplary platform in computer accessible memory as the exemplary Influencer User's exemplary Platform Payment Instrument.

In reference to FIG. 12, as detailed in exemplary function 1202, the exemplary platform would be notified of the Influencer's attempted purchase and/or completed purchase in real time. In one exemplary embodiment, the exemplary platform would be notified about the Influencer's purchase directly by a co-branded card network partner (such as, for example, Mastercard™) through a direct integration with the co-branded network partner. As will be understood by someone with ordinary skill in the art, an application programming interface (API) could be used to communicate directly between the exemplary network partner and the exemplary platform.

In one exemplary embodiment, the exemplary platform would store the received transaction details in a transaction database record in association with the Influencer User. In one exemplary embodiment, transaction details would include a retailer or service provider name, transaction location, transaction time, transaction amount, transaction payment method, and any other data otherwise known at the time of a transaction.

In one exemplary embodiment, the exemplary platform would automatically add tracked exemplary Influencer's transaction activity to an exemplary platform feed. Exemplary platform feed could include tracked transaction details (such as, for example, user name, transaction amount, transaction merchant name, merchant location, item(s) purchased or any other information known about tracked transaction or in the future learned). In one exemplary embodiment, an exemplary tracked transaction activity could create a new unique Post on exemplary Platform's feed. In another exemplary embodiment, exemplary tracked transaction activity could be used to update an existing Post on exemplary platform's feed. In some exemplary embodiments, exemplary platform Users will be able to interact with an exemplary Post through a comment or the like. As will be understood by someone with ordinary skill in the art, a “comment” or “like” is a commonly used method in social media to interact with a Post. In one exemplary embodiment, exemplary User would be able to add additional content to automatically added or updated Post on exemplary platform feed (such as, for example, an image or images of product(s) purchased, a video, an Emoji or any additional details about exemplary transaction that exemplary User would like to add).

In reference to FIG. 12, in one exemplary embodiment as detailed in exemplary function 1203, following an Influencer purchase, the exemplary platform would make available to said Influencer a record of the Influencer's prior purchases. As will be understood by someone with ordinary skill in the art, the exemplary platform could show a variety of transaction details including transaction date and time, transaction retail location, transaction amount, transaction purchase details (as an example, items purchased or services paid for) to provide the Influencer with enough detail to recognize a given purchase. In one exemplary embodiment, the exemplary platform would alert the Influencer User to a purchase transaction in real time using an in-app push notification. In some exemplary embodiments, the exemplary platform would alert the Influencer User to a transaction at a later time following the completion of a purchase transaction.

In one exemplary embodiment, as detailed in exemplary function 1204 in FIG. 12, for a purchase transaction that an exemplary Influencer would like to share, the Influencer would communicate to the exemplary platform—such as, for example, through a swipe, tap, click or any other interaction made possible through a User device whether now known or in the future discovered—the Influencer's desire to share purchase transaction details through the exemplary platform.

As will be understood by someone with ordinary skill in the art, to “share” within the context of social networking is defined as making available to other participants in the social network platform. In one embodiment, content could be shared publicly or privately. Content that is shared publicly means the content could be made available to all Users—including possibly even Users who are not yet enrolled Users but at a minimum able to access the exemplary platform—without any restrictions. In another embodiment, content may be published or shared in a private manner. To share privately means the content owner—in an exemplary platform this could be the Influencer User or the exemplary platform itself—would be able to decide who, which users, or which devices would be able to view shared content. As a non-limiting example, content may be shared privately with specific individual users, a group of users, no users, all eligible enrolled users, or any eligible device with access to the exemplary platform.

In reference to FIG. 12, in one exemplary embodiment as depicted in exemplary logic function 1205, upon selecting the purchase transaction the Influencer User would like to share, the exemplary system would prompt the Influencer to provide additional optional content or details about the selected purchase transaction. As a non-limiting example, an exemplary platform would prompt the Influencer to scan a receipt detailing the item (or items) purchased or service (or services) received, to take a photo of the item (or items) purchased or service (or services) received, or to provide a description of the item (or items) purchased or service (or services) received.

As will be understood by someone with ordinary skill in the art, by scanning a receipt using real time augmented reality technology (such as, for example, through www.taggun.io), an exemplary platform would provide an exemplary Influencer with an easy method of sharing purchase transaction details on a per item or per service received level of specificity with the exemplary platform following a tracked Influencer purchase transaction.

As will be understood by someone with ordinary skill in the art, the purpose of the exemplary platform prompting the Influencer to provide additional content based upon the selected transaction would be to share as much detail with the Influencer's fans as possible in an effort to influence an Influencer's Fan's purchase decision. The above exemplary prompts that the exemplary platform could make to an exemplary Influencer (such as, for example, a prompt to scan receipt transaction receipt) are non-limiting as there are a variety of ways in which an Influencer can provide additional details to drive Fan influence such as through custom content (such as, for example, a video description, video tutorial or in-use video content).

As shown in exemplary function 1206 in FIG. 12, in one exemplary embodiment, the exemplary platform would determine (such as, for example, through the Influencer's scan of a transaction receipt) if there is more than one item or service in a consummated Influencer purchase transaction. If the exemplary platform determines there is more than one item or service, in one exemplary embodiment as shown in exemplary function 1207 in FIG. 12, the exemplary platform would prompt the Influencer to identify which item(s) or service(s) the Influencer would like to share. Continuing in reference to FIG. 12, in one exemplary embodiment as shown in exemplary function 1208, the Influencer would select the item(s) or service(s) the Influencer would like to share and then would add additional optional content regarding selected transaction, item(s) and/or service(s). In one exemplary embodiment, the Influencer would rate the transaction (such as, for example, rate the quality of the product or service received, or rate the merchant itself by selecting one to five potential stars as an indication of level of satisfaction). As will be understood by someone with ordinary skill in the art, by rating a transaction Users will find a recommendation (whether positive or negative) more informative, helpful and authentic.

Continuing with reference to FIG. 12, in one exemplary embodiment as detailed in exemplary function 1209, after an Influencer has added additional optional content regarding selected transaction, the Influencer would then make transaction data available through the exemplary platform by prompting the exemplary platform to Post transaction data (such as, for example, through a click, tap, swipe or other interaction made possible through User device and transmitted to the exemplary platform). As will be understood by someone with ordinary skill in the art, transaction data could be made available through an exemplary platform feed (such as, for example, a social network “wall”). In the context of describing exemplary embodiments, the term feed will be understood to be a data format used for providing users with updated content.

In some embodiments, an Influencer may opt to schedule a Post to be made available on an exemplary platform feed at a later date sometime in the future using the present invention. In such an embodiment, this would provide an exemplary Influencer the flexibility and convenience of scheduling Posts in the future. The ability to schedule Posts to be shared sometime in the future also provides a security mechanism to ensure an Influencer's real time location details do not have to be shared publicly in the event the Influencer would like to keep real time location private. In some exemplary embodiments, an Influencer User would decide to share purchase transaction details in real time.

In some embodiments, a User may opt to share (such as, for example, through an exemplary platform Post) transaction details associated with a transaction that was not completed using an exemplary platform payment card (such as, for example, a transaction completed using an Influencer's personal card that had not been provided by exemplary platform or added into exemplary platform). In some embodiments, an Influencer may opt to share (such as, through an exemplary platform Post) details about a future transaction or recommendation that an Influencer may want to share with exemplary platform Users.

In some exemplary embodiments of the present invention, shared User Posts would be aggregated and organized based upon the merchant (such as, for example, all User Posts advertising Retailer A's products and services would be aggregated and presented on a page dedicated to Retailer A). In one exemplary embodiment, a retailer page would be automatically generated by exemplary platform immediately once an exemplary Platform Payment Instrument has been used to complete a purchase at said retailer. In some embodiments, a retailer page would be automatically generated by exemplary platform immediately once a User has shared a Post sharing a tracked purchase at Retailer A. In some embodiments, a retailer page would be manually created (such as, for example, by the exemplary platform company, an exemplary user, or an exemplary retailer). In some embodiments, a retailer page would have a feed consisting of all shared User Posts and also contain additional details about the retailer (such as, for example, location, hours of operation, products or services, prices, or any other information whether user generated or exemplary platform generated). As will be understood by someone with ordinary skill in the art, by having a dedicated page for each retailer, it would be much easier for Users to learn more about a particular retailer and see all purchase-verified recommendations for the same retailer in a single feed.

In some exemplary embodiments of the present invention, each User would have his or her own profile page on which a personal feed would contain all shared Posts. As will be understood by someone with ordinary skill in the art, providing each User with an individual profile page makes it easier for Users to follow, filter and view a specific User's Posts in a single location.

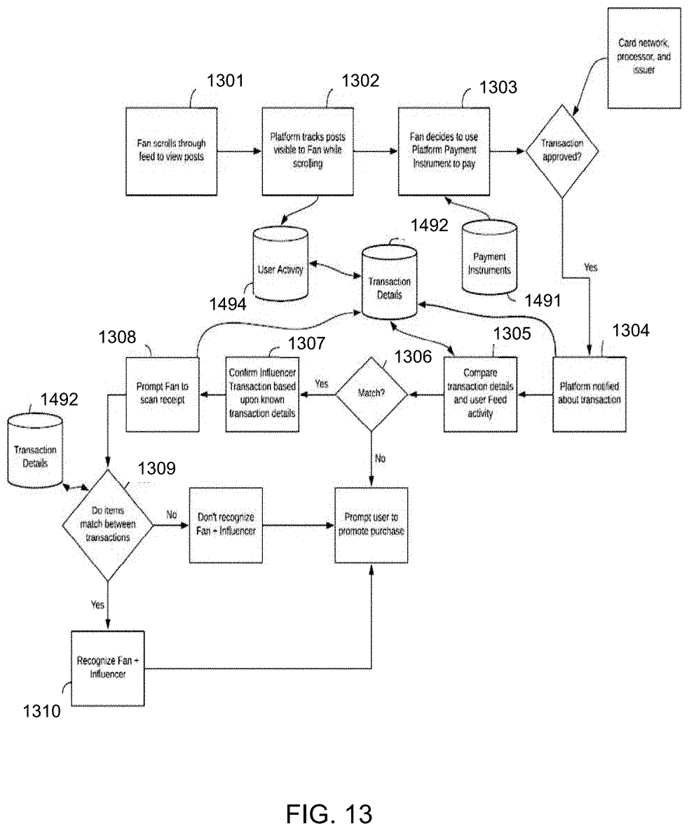

FIG. 13 depicts high-level logic functions for a Fan User's overview perspective of an Influencer-Influenced-Fan-Purchase in an exemplary embodiment of the present invention. In the context of describing one exemplary embodiment of the present invention, a Fan will be understood to be a User who has opted to follow an Influencer and view Posts an Influencer shares based upon payment transactions. In the context of describing exemplary embodiments, to follow will be understood to mean a User has opted (such as, for example, through settings within the exemplary platform) to be made aware of activity an Influencer or other entity participating in the exemplary platform completes (such as, for example, an Influencer transaction Post).

In one exemplary embodiment, an exemplary Fan's feed would include individual Posts from unique Influencers. An exemplary platform Post could include information such as the Influencer's name or Influencer's username (such as, for example, a username created when registering for the exemplary platform, or a username associated with another common social network such as Facebook™ or Instagram™), the Influencer's profile picture, transaction details (such as, for example, the transaction location, retailer location, transaction time, transaction total, item(s), transaction type, image of the transaction, what was transacted, or service(s) received) and any additional content provided by the Influencer to be shared along with transaction data (such as, for example, an image of product(s) or service(s) received, a video of product(s) or service(s) received or any other data whether written, recorded or otherwise made available by the Influencer to the exemplary platform).

In one exemplary embodiment, advanced computer programmed instructions would be operably installed on an exemplary User device instructing the User device to present an exemplary feed of Influencer Posts, track the exemplary User's view of the exemplary Influencer Posts and track exemplary User's purchase transactions to confirm Influencer-Influenced-Fan-Purchases.

In one exemplary embodiment, an exemplary Fan would scroll through a feed of Influencer Posts made available through the exemplary platform detailing Influencer-shared transaction data.

As FIG. 13 depicts in exemplary function 1301, in one exemplary embodiment, a User would scroll through one's own feed to view transaction data content (such as, for example, Posts) made available by other exemplary platform Users (such as, for example, an Influencer User). Feed content (such as, for example, which Posts appear when an exemplary Fan scrolls through the feed) may be filtered by actions the exemplary Fan has completed or automatically curated based upon the Fan's preferences. In one exemplary embodiment, a Fan could filter one's own feed based upon transaction type (such as, for example, restaurant transactions), Influencer type (such as, for example, musicians), or specific Influencer (such as, for example, a specific famous actor).

Feed content may also be curated by the platform provider based upon a Fan's self-identified—or platform-identified—preferences. In one exemplary embodiment, preferences could be determined by the exemplary platform based upon a Fan's self-identified preferences, or Fan behavior when using the platform (such as, for example, through Fan's own purchase behavior, interaction with other platform Users (such as, for example, other Fans, Influencers, Merchants, or otherwise), the Fan User's physical location (such as, for example, by using Location Services capability on Apple™ iPhone devices), or otherwise determined by the exemplary platform using custom coded computer algorithms (such as, for example, algorithms operably installed on a User device or algorithms operably installed in the exemplary platform's computer accessible memory). In one exemplary embodiment, exemplary Users would be able to filter a feed based upon Post popularity (such as, for example, based upon exemplary platform User interactions with the Post—such as through “Likes” or “Comments”—or, as summarized in more detail below, based upon the number of total Influencer-Influenced-Fan-Purchases per Post). In one exemplary embodiment, exemplary Users would be able to filter a feed's Posts based upon geographic location (such as, for example, the feed would show Posts associated with merchants located within a geographic region close to—or defined by—the exemplary User).

As FIG. 13 depicts, in one exemplary embodiment as detailed in exemplary function 302, while a Fan scrolls through one's own feed, the exemplary platform would automatically track which shared Influencer Posts the Fan has viewed and the exemplary platform would store a record (such as, for example, a record in a computer accessible database used to store Fan activity and Fan interactions with the exemplary platform feed). In one exemplary embodiment, Fan A would view an image shared by an exemplary Influencer based upon Influencer's own purchase and transaction data (such as, for example, a fashion Influencer would share an image of a new clothing item recently purchased with information about said item including, as an example, the item's price, purchase location, description, or any other information the Influencer shares with the exemplary platform to influence a Fan's decision to also purchase the shared item).

Continuing in reference to FIG. 13, as shown in exemplary function 1302, upon viewing an exemplary Post, the exemplary platform would automatically track that Fan A had viewed the exemplary Post through the advanced computer program code described below. Reference herein to automatic tracking is illustrative and is not a limitation of the present invention. Rather, in some exemplary embodiments such tracking could be done through direct Fan interaction with an Influencer content Post (such as, for example, by a Fan User double-tapping, swiping on, clicking or otherwise interacting with a shared Influencer Post within the Fan's feed using the Fan's User device).

In one exemplary embodiment, as a User (such as, for example, a Fan) scrolls through a feed, some or all Posts that are visible to the User are tracked. In one exemplary embodiment, Post tracking is achieved on the Apple™ iOS platform through the use of ‘UIScrollView’ functionality. In one exemplary embodiment, when the ‘UIScrollView’ method ‘scrollViewDidScroll’ is triggered through software code, the cells contained in the feed are tested for visibility. As will be understood by someone with ordinary skill in the art, in one exemplary embodiment each exemplary Post would be positioned within a unique cell made possible through custom-written software programming. Cell visibility can be determined by comparing the ‘CGRect’ coordinates of an exemplary individual Post's cell to the ‘CGRect’ of the parent container that is bound to the User device's visible window. In one exemplary embodiment, the individual Post visibility is part of an exemplary algorithm used to calculate attributing influence and various metrics regarding each Post are captured as input parameters (such as, for example, Post visibility and Post view duration). Reference herein to various metrics regarding each Post is illustrative and is not a limitation of the present invention. Rather, in some exemplary embodiments, Post interaction and Post reactions (such as, for example, a Fan User double-tapping on a Post) would be part of the algorithm for attributing influence.

In one exemplary embodiment, a scoring algorithm for attributing influence would incorporate the time duration of Post visibility to quantify influence. In one exemplary embodiment, a number of points would be tallied towards an influence total value with more points being rewarded based upon higher Post visibility time duration. In some embodiments, each parameter identified by the exemplary platform would be used when calculating an influence total value.

In some exemplary embodiments, a scoring algorithm for attributing influence would incorporate the number of followers an Influencer has, the variety of Influencer Posts (such as, for example, number of positive and/or negative recommendations based upon Influencer transaction rating), Fan engagement (such as, for example, the percentage of Fans that actually follow an Influencer's recommendations and make the same or similar purchases resulting in Influencer-Influenced-Fan-Purchases), and Fan rating alignment (such as, for example, when Fans complete Influencer-Influenced-Fan-Purchases do Fans rate transactions the accordance with Influencer rating—thereby showing that Fans agree with Influencer recommendations—or do Fans rate differently as compared to Influencer rating—thereby showing that Fans disagree with Influencer recommendations). In one exemplary embodiment, the exemplary platform would calculate a unique Influencer Influence Score for each Influencer User. In some exemplary embodiments, exemplary platform would share the exemplary Influencer Influence Score publicly. In some embodiments, exemplary Influencer Influence Score would be used internally by exemplary platform but not shared publicly.

In one exemplary embodiment, the exemplary platform would make available an “offline mode” in the event the exemplary User's device does not have an Internet connection. In one embodiment, the exemplary platform would make available to the exemplary User (such as, for example, through an exemplary mobile application) feed content that had been previously saved using computer accessible memory without requiring the use of an Internet connection (such as, for example, by using the User device's memory). As will be understood by someone with ordinary skill in the art, an exemplary mobile application could pre-load feed content onto the exemplary User device when the device has an Internet connection so that the content can be shown to exemplary User in the event exemplary device no longer has an Internet connection. The ability to pre-load data would ensure a good user experience even in situations when an Internet connection may not be available or may not be reliable.

In one exemplary embodiment of the present invention, Users would scroll through a feed made available by another social network platform (such as, for example, Instagram™) and view the exemplary platform's exemplary Influencer User's Post. In such an embodiment, the exemplary platform could track exemplary User's view of the exemplary Influencer User's Post using a hyperlink (such as, for example, a short link) associated with the Influencer's Post. In some exemplary embodiments, an exemplary Influencer would post an image along with a short link. An exemplary Fan could click (such as, for example, through a tap on a mobile device screen or by using the keypad or mouse on a traditional computer device) on the exemplary short link. In one exemplary embodiment, when clicked, the exemplary short link could load a website built and provided by the exemplary platform. Exemplary website could automatically (such as, for example, through the use of website browser cookies) determine if an exemplary platform User is logged in or not. If the exemplary User is logged in, the exemplary platform could track whether that exemplary User had viewed the exemplary Influencer User's Post based upon the exemplary website having been loaded following the exemplary Fan having clicked on the exemplary short link. In one exemplary embodiment, if the exemplary website is not able to determine whether the exemplary User is logged in, the exemplary website could be programmed to prompt the exemplary User to login or register. As will be understood by someone with ordinary skill in the art, the exemplary platform would be able to confirm the exemplary User's identity and track whether that exemplary User had viewed an exemplary Influencer's Post through an outside channel (such as, for example, another social media platform such as Facebook™ or YouTube™) using the method described above.

Continuing with reference to FIG. 13 as depicted in exemplary function 303, after scrolling through a feed, an exemplary Fan would decide to use an exemplary Platform Payment Instrument (such as, for example, the above identified InCard) to consummate a payment transaction. In one exemplary embodiment, following an exemplary Fan's use of a Platform Payment Instrument to make a payment transaction, the exemplary platform would be notified. In one exemplary embodiment, an exemplary Fan would make a purchase online (such as, for example, through a website or mobile application). In another exemplary embodiment, an exemplary Fan would make a purchase in-person (such as, for example, at a physical location). As will be understood by someone with ordinary skill in the art, the channel through which a transaction is completed is not limited and includes any electronic channel whether now known or in the future discovered to be capable of communicating with an exemplary platform of the present invention. In other exemplary embodiments, an exemplary Fan would make a purchase using exemplary platform's mobile application (such as, for example, a Fan would see a particular transaction while scrolling through the exemplary platform's Feed, decide to make the same purchase and complete the purchase directly through the exemplary platform mobile application (such as, for example, by clicking, tapping, swiping or similar interaction from within the exemplary platform mobile application—such as directly on the viewed Influencer Post—and then completing a checkout flow to complete a purchase)).

As will be understood by someone with ordinary skill in the art, an exemplary platform could be notified in real time of a Fan's attempted use of Platform Payment Instrument (such as, for example, through an authorization alert provided by a card network such as Mastercard™) and/or the exemplary platform could be notified following a successful use of an exemplary Platform Payment Instrument.

Continuing with reference to FIG. 13 as shown in exemplary function 304, following a successful use of an exemplary Platform Payment Instrument, the exemplary platform would receive transaction details. Transaction details could include merchant location, merchant name, payment total, payment time, items received or services received. As will be understood by someone with ordinary skill in the art, the transaction details summarized above are non-limiting and the term transaction details includes whatever is known at the time of transaction or in the future discovered about the transaction.

As depicted in FIG. 13 in exemplary function 1305, in one exemplary embodiment, an exemplary platform would compare received Fan transaction details to transaction details associated with the Fan through the content the Fan is known to have viewed while browsing an exemplary platform feed (such as, by example, using an exemplary database used to store Fan activity and interactions with an exemplary platform feed). Continuing with reference to FIG. 13, as depicted in exemplary function 306, in one exemplary embodiment, the exemplary platform would determine if there is a match between received exemplary Fan transaction details and exemplary Influencer transaction details previously stored in the exemplary platform and in relation to the Fan based upon the Fan's prior interaction with an exemplary platform feed.

As will be understood by someone with ordinary skill in the art, in some exemplary embodiments there are other ways in which a User may decide to consummate a payment transaction (such as, for example, by using a payment method not yet registered with the exemplary platform) after having viewed a Post through the exemplary platform. In one such embodiment, as will be understood by someone with ordinary skill in the art, an exemplary platform would be able to retrieve User transaction details (such as, for example, from third party data aggregation services or by exemplary User providing exemplary platform with access to outside payment methods—such as, for example, by linking a payment account after a purchase has been made through a service such as Plaid.com and providing exemplary platform with access to historical transaction data) in the event an exemplary Platform Payment Instrument had not been used in order to successfully track a transaction back to an exemplary User having viewed an Influencer's Post when calculating Influencer-Influenced-Fan-Purchases.

In one exemplary embodiment and in addition to tracking User purchase activity, an exemplary platform would track User actions after having tracked a User view of Influencer Post through the exemplary platform. In such an embodiment, an exemplary platform would track User in-store visits (such as, for example, by using Bluetooth Low Energy—commonly referred to as BLE—technology to identify when a User device has entered a particular location—such as a retailer location) or online browsing activity (such as, for example, through the use of understood cookie technology). As will be understood by someone with ordinary skill in the art, the above examples of User actions are illustrative and not a limitation of the present invention. Rather, in some exemplary embodiments, location tracking (such as, for example, Apple™ Location Services) could be used to track User in-store visits. As will be understood by someone with ordinary skill in the art, the ability to track User view of Influencer Recommendation and following User action is of great value for all parties involved in commercial transactions (such as, for example, Influencers, Users, retailers and marketers) and there are many User actions which could be tracked through the present invention.

As depicted in FIG. 13 exemplary function 1307, in one exemplary embodiment, if there is a transaction match between an exemplary Fan's transaction, and at least one Influencer's previous transaction based upon the Fan's previous interaction with an exemplary platform feed (such as, for example, an exemplary Fan double-tapped on an Influencer's shared Post while viewing a wall on the exemplary platform), the exemplary platform would recognize the Fan's purchase as having been influenced by the Influencer's purchase and therefore confirm it as an Influencer-Influenced-Fan-Purchase. In the event there is more than one match (such as, for example, a Fan's transaction data matches with two or more Influencers' transaction data already stored in the exemplary platform database and in relation to the Fan based upon the Fan's activity), in one exemplary embodiment, the exemplary platform would prompt the Fan to identify which Influencer influenced the confirmed Influencer-Influenced-Fan-Purchase. As will be understood by someone with ordinary skill in the art, an exemplary platform could prompt an exemplary Fan to identify which Influencer influenced the confirmed Influencer-Influenced-Fan-Purchase by presenting to the Fan a list of each matched Influencer (such as, for example, through a graphical interface made available to the exemplary Fan through the Fan's User device), and by prompting the Fan User to select (such as, for example, by a tap, swipe, touch and hold, or any interaction made possible through a User's device and communicated to the exemplary platform) the Influencer responsible for influencing the tracked exemplary Influencer-Influenced-Fan-Purchase. In other exemplary embodiments, the exemplary User would use voice or audio to interact with the exemplary platform.

In one exemplary embodiment, the exemplary platform would update the exemplary Influencer's original Post (such as, for example, the Influencer's Post that exemplary User viewed before completing a matching transaction) to reflect that the exemplary User had completed a matching transaction (such as, for example, by increasing a total count associated with the exemplary Post used to indicate how many Users have completed a matching transaction). In some exemplary embodiments, the exemplary platform would have a numerical count to represent the number of exemplary Users that have made matching purchases to the exemplary Post (such as, for example, a total count of Influencer-Influenced-Fan-Purchases associated with the exemplary Post). In some exemplary embodiments, the exemplary platform would show a list of exemplary Users who had made matching purchases to the exemplary Post (such as, for example, similar to how the social network Twitter™ shows a list of users who have “Liked” a tweet). As will be understood by someone with ordinary skill in the art, by showing a list of exemplary Users who have completed matching transactions, the exemplary platform would be able to provide platform Users with social proof and give platform Users an indication of which transactions are most popular. As will be understood by someone with ordinary skill in the art, there are a variety of ways in which the exemplary platform could recognize when exemplary Users complete matching transactions (such as, for example, by creating a comment underneath a previous Post, by creating another Post automatically, by showing a list of User names or by showing a list of User profile images) without departing from the spirit of the present invention.

Continuing in reference to exemplary function 1308 in FIG. 13, in one exemplary embodiment, if a Fan's purchase is determined by the system to be an Influencer-Influenced-Fan-Purchase, the exemplary platform would prompt the Fan (such as, for example, through a mobile application “push notification”) to scan the Fan's purchase transaction receipt. As will be understood by someone with ordinary skill in the art, by scanning the purchase transaction receipt, the Fan would share with the exemplary system specific details about the item(s) or service(s) in the Fan's purchase transaction. In one embodiment, as detailed in exemplary function 1309 in FIG. 13, the exemplary platform would use additional item- and/or service-specific transaction details to determine if the exemplary Fan had purchased some or all of the same item(s) and/or service(s) that the exemplary Influencer had purchased before the Influencer shared purchase details with the Fan through the Influencer's Post on an exemplary platform's wall.

In one exemplary embodiment, the exemplary platform would receive Fan entry of item(s)- or service(s)-specific details (such as, by example, through real time receipt scanning as defined above), store received item(s)- or service(s)-specific details in a computer accessible memory (such as, for example, a database), compare received transaction details to already saved Influencer payment transaction item(s)- or service(s)-specific details and determine if there is a further match between the Fan and the Influencer's purchase transactions based upon confirmed and tracked item(s) purchased and/or service(s) received.

Continuing in reference to FIG. 13 in exemplary function 1310, in one exemplary embodiment, if an exemplary platform determines there is an Influencer-Influenced-Fan-Purchase that also includes matching item(s) or service(s), an exemplary platform would recognize both the Influencer and the Fan for said Influencer-Influenced-Fan-Purchase. In one exemplary embodiment, the exemplary platform would provide the Influencer with cash back based upon the Fan's purchase amount. In one exemplary embodiment, the exemplary platform would provide the Fan with rewards points based upon the payment transaction. Reference herein to cash back and rewards point recognition is illustrative and is not limiting of the present invention. Rather, in some exemplary embodiments, merchant discounts, coupon codes, or other valuable form of recognition as made available by the exemplary platform and recognized by exemplary platform Users could be provided as recognition of an Influencer-Influenced-Fan-Purchase. In some exemplary embodiments, an exemplary platform would recognize an exemplary Influencer User and/or exemplary Fan User following a tracked Influencer-Influenced-Fan-Purchase that does not also include matching item(s) or service(s) (such as, for example, an Influencer-Influenced-Fan-Purchase that includes matching transaction location details but does not include matching item(s) or service(s) details).

In one exemplary embodiment, exemplary platform Fan Users would earn exemplary platform reward points following a successfully tracked Influencer-Influenced-Fan-Purchase. In such an embodiment, exemplary platform rewards points would be redeemable for exclusive offers, rewards, or experiences made available through the exemplary platform by exemplary platform or by Influencer Users (such as, for example, an opportunity to take cooking lessons with a celebrity chef, meet a celebrity musician backstage or go shopping with a fashion industry leader). In one exemplary embodiment, an exemplary Fan User would receive more exemplary platform rewards points based upon how many transaction details matched between the tracked Influencer Post and the tracked Fan User payment transaction (such as, for example, the exemplary Fan User would receive 1 point if the exemplary Fan completed a purchase at the same retail location advertised by the Influencer Post, or 5 points if the exemplary Fan completed a purchase at the same retail location and bought the same item as advertised by the Influencer Post).

In one exemplary embodiment, the exemplary platform would track repeat purchases (such as, for example, a transaction that an exemplary User has completed more than one time). In some exemplary embodiments, the exemplary platform would take into consideration whether an exemplary User has completed a repeat purchase (such as, for example, when calculating cash back for an exemplary User, rewards points earned, or cash back for an exemplary Influencer). As will be understood by someone with ordinary skill in the art, in some exemplary embodiments, an exemplary platform would take into consideration if an exemplary User has completed a repeat purchase for a variety of reasons, including when calculating cost per thousand (“CPM”), cost per click (“CPC”) or revenue share. Each of these concepts is defined and/or discussed in more detail later in the present application).

### Retailer Participation

Retailers are always struggling to identify the best way to reach their most loyal customers while at the same time engaging new customers. Some retailers are not in a position to personally engage influencers or provide customers with special offers. In the context of describing alternative exemplary embodiments, the term retailer will be understood to mean any entity in the business of selling goods or services directly to consumers or other businesses.

A retailer may refuse to pay an upfront fee to an Influencer to Post content (such as, for example, a fixed amount to an Influencer to Post an image on a social network such as Instagram™) about the retailer or the retailer's products available for purchase without having the ability to track actual value created (such as, for example, through converted retailer sales) that can be directly attributed to an Influencer's influence in driving sales volume.

In addition, a retailer may not be interested, willing, or able to change its existing systems (such as, for example, eCommerce website checkout) to configure a traditional referral type program (such as, for example, the Amazon™ Associates affiliate program) through which affiliates would use hyperlink technology to track affiliate purchases.

Some way is needed for retailers to reliably confirm the total payment transaction volume an Influencer influences based upon the ability to track an Influencer's promotion, i.e., tracking a User's view of the Influencer's promotion prior to a User's payment transaction consummation, and then matching a User's payment transaction consummation with the Influencer's promotion. Some exemplary embodiments of the present invention would provide retailers with real-time tracking of Influencer payment transaction consummation, Influencer promotion, confirmed User views of an Influencer promotion, User payment transaction consummation and confirmation of a match between User payment transaction and an Influencer promotion.

By providing retailers with the ability to track an Influencer's purchases, an Influencer's Posts directed towards Fans/Users in an effort to influence User/Fan purchase behavior and a User/Fan's purchases, exemplary embodiments of the present invention provide retailers the ability to make unique offers available to Influencers and/or Users/Fans based upon tracked and confirmed payment transactions.

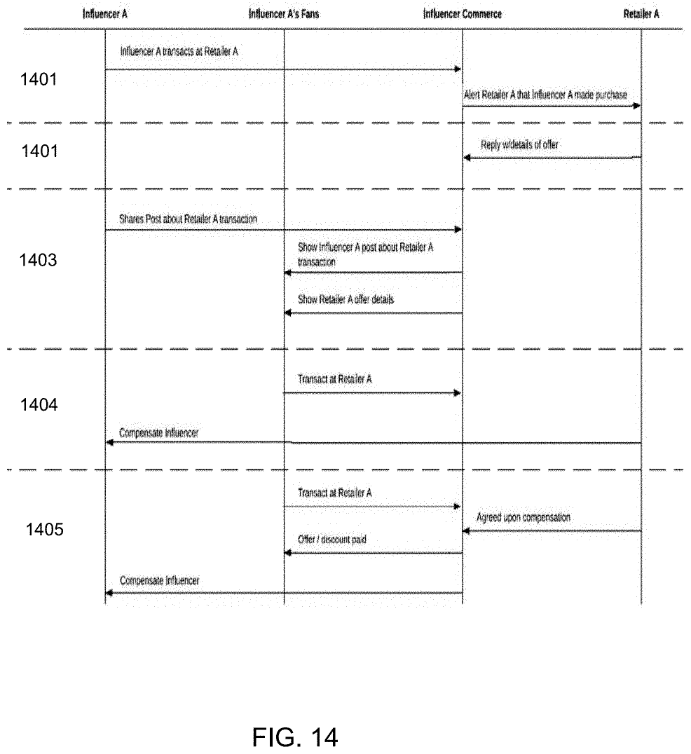

FIG. 14 depicts a high-level summary of interaction between an exemplary retailer (“Retailer A”) and an exemplary platform (“Influencer Commerce”) in one exemplary embodiment of the present invention. As depicted in FIG. 14 in exemplary situation 1401, in one exemplary embodiment, the exemplary platform would automatically notify Retailer A when Influencer A has transacted at Retailer A. In another embodiment of the present invention, the exemplary platform would automatically notify Retailer A when Influencer A has decided or opted to share a purchase transaction from Retailer A with exemplary platform Users. As will be understood by someone with ordinary skill in the art, the exemplary platform would be able to notify Retailer A through a variety of communication channels (such as, for example, an automated phone call, email or personalized phone call). Reference herein to communication channels through which the exemplary platform could automatically notify Retailer A are illustrative and not limiting. Rather, in some exemplary embodiments, a retailer may be a User of the exemplary platform and be notified via a text message, mixed media message or app alert message. In one exemplary embodiment, in response to being alerted by an exemplary platform, Retailer A would respond to the exemplary platform with an offer to be made available by the exemplary platform to its Users.

Continuing in reference to FIG. 14, as depicted in exemplary situation 1402, in one exemplary embodiment, Retailer A would opt to offer a discount to all enrolled Users in the exemplary platform. As will be understood by someone with ordinary skill in the art, Retailer A may decide to limit any discount or offer to a subset of an exemplary platform's Users (such as, for example, only enrolled users, only enrolled users who have purchased a particular item, or only enrolled users who are a Fan of a particular Influencer).

Reference herein to ways in which a retailer may decide to limit any discount or offer made available to Users through exemplary platform is illustrative and is not a limitation of the present invention. Rather, in some exemplary embodiments, an exemplary retailer may decide to make a cash back offer available that is only redeemable by Fans of a specific Influencer and only after eligible Fans have purchased a specific product. In some exemplary embodiments, an exemplary retailer may limit discounts or offers as single use (such as, for example, each User would only be able to redeem an offer one time), or multi-use (such as, for example, each User would be able to redeem an offer more than one time, or on a regular schedule (such as, for example, once per month)). The present invention would be able to provide retailers the flexibility to create incentive-based programs (such as, for example, cash back programs similar to the 5% cash back offer made available through the Target™ Red Card) and restrict such programs based upon the exemplary platform's access to tracked User activity using the exemplary platform (such as, for example, a Fan's scrolling through a feed and viewing an Influencer's Post) and tracked User payment transaction data (such as, for example, transaction data made available to the exemplary platform through card networks such as Mastercard™).

Continuing with reference to FIG. 14, as depicted in exemplary situation 1403, in one exemplary embodiment, Retailer A would decide to offer a discount (such as, for example, $5 off a User's first purchase of at least $50) through the exemplary platform. In one exemplary embodiment, Retailer A would ask the exemplary platform to only make an exemplary discount available to Influencer A's Fans. As shown in exemplary situation 1403 in FIG. 14, in such an exemplary embodiment, the exemplary platform would make Retailer A's discount available to Influencer A's Fans by including information concerning the discount directly below Influencer A's Post on an exemplary Fan's wall within the exemplary platform.

In one exemplary embodiment, the exemplary platform would link retailer discounts and/or offers directly to an exemplary Platform Payment Instrument. In one exemplary embodiment, the exemplary platform would link retailer discounts to an exemplary platform issued Platform Payment Instrument (for example, such as, a co-branded Mastercard™) as a card-linked-offer. As will be understood by someone with ordinary skill in the art, a card-linked-offer is a rewards, discount or offer that is applied to a consumer's payment instrument following a purchase using said payment instrument.

In one exemplary embodiment, the exemplary platform would create card-linked-offers directly through an API made available by a co-branded card network (such as, for example, Mastercard™) or through a third party solution provider (such as, for example, a third party provider similar to http://cardspring.com/).

In one exemplary embodiment, the exemplary platform would integrate directly with retailer point-of-sale systems in order to apply relevant retailer discounts and/or offers.

In some exemplary embodiments, a retailer would ask the exemplary platform to make a discount or offer available to exemplary platform Users automatically anytime an Influencer decides to share a Post about a payment transaction associated with said retailer. In one such embodiment, an exemplary platform would automatically make Retailer A's discount or offer available to eligible exemplary Users once pre-defined actions have taken place (such as, for example, an Influencer having made a payment transaction associated with Retailer A, or an Influencer having shared a Post related to a payment transaction associated with Retailer A).

In one exemplary embodiment, immediately following a confirmed Influencer-Influenced-Fan-Purchase, Retailer A would provide the Fan with a cash back offer. The above reference to a cash back offer is illustrative and is not a limitation of the present invention. Rather, in some embodiments, a retailer might offer a “buy one get one free” deal. As will be understood by someone with ordinary skill in the art, it is possible to provide different deals and/or offers without departing from the spirit of the present invention.

As depicted in FIG. 14 in exemplary situation 1404, in one exemplary embodiment, a retailer could also compensate an exemplary Influencer in return for influencing a Fan's payment transaction (such as, for example, through a revenue share of Fan's payment transaction amount or a revenue share of Fan's payment transaction amount spent on specific exemplary item(s) and/or service(s)).

In some embodiments, as depicted in exemplary situation 1405 in FIG. 14, an exemplary retailer would not be able to communicate directly with an exemplary Influencer, but instead all communication including program configuration and any transfer of funds would be managed directly by the exemplary platform. In some embodiments, retailer would pay the exemplary platform all funds required to provide the exemplary User discount and compensate all parties involved in the program (such as, for example, an Influencer, a Fan, an exemplary platform, a retailer, or a product manufacturer).

In some embodiments, other entities involved in the sale of goods or services (such as, for example, product manufacturers, marketing agencies, or distribution companies) would make discounts and/or offers meant to incentivize purchases available to exemplary platform Users. Such offers could be made available as detailed above.

In one exemplary embodiment, an exemplary marketer (such as, for example, a retailer) would pay exemplary platform Users based upon the number of clicks or views individual Posts have received. In one such embodiment, an exemplary marketer would have various methods by which to calculate compensation (such as, for example, a CPM or revenue share based upon tracked purchase volume). As will be understood by someone with ordinary skill in the art, CPM is an advertising term referring to advertising bought on the basis of one thousand impressions. In one exemplary embodiment, a CPC (“cost per click”) would be used instead of the above defined CPM. As will be understood by someone with ordinary skill in the art, a CPC is the cost per click charged in the event a link is used to track Posts (as defined above).

In one exemplary embodiment, an exemplary marketer would pay an exemplary Influencer based upon the number of times exemplary Fans have viewed an exemplary Post (such as, for example, if CPM equals $1.00 and 2,000 users have viewed a particular Post, the marketer would pay $2.00). In some embodiments, an exemplary marketer would agree to a revenue share with an exemplary Influencer based upon the total sale amount influenced through the exemplary platform (such as, for example, a percentage of the total amount associated with Influencer-Influenced-Fan-Purchases for a given exemplary Influencer). In some embodiments, an exemplary marketer would use a hybrid model that includes the greater of either “X” CPM or “Y”% revenue share. In some embodiments, an exemplary marketer would use a hybrid model that includes the greater of either “X” CPC or “Y”% revenue share. In one exemplary embodiment, an exemplary marketer would use a minimum CPM or “Y”% revenue share. In one exemplary embodiment, an exemplary marketer would agree to a price per swipe model (such as, for example, a price would be paid based upon the number of unique times an advertisement has been swiped through the use of a model application). As will be understood by someone with ordinary skill in the art, the above examples are illustrative and not a limitation of the present invention. Rather, as will be understood by someone with skill in the art, there are a variety of ways in which a hybrid pricing model could be defined without departing from the spirit of the present invention (such as for example, a price per engagement minus a price per swipe model).

In some exemplary embodiments, an exemplary retailer would be able to view all previous Posts with the transaction data associated with said exemplary retailer in an easy to navigate electronic interface. In this embodiment, an exemplary retailer would be able to select which Posts the exemplary retailer would like to promote within the exemplary platform. By being able to select specific Posts to promote, it will be understood by someone with ordinary skill in the art, exemplary retailers would have control over highlighting that a specific User (such as, for example, an Influencer) had interacted (such as, for example, through making a tracked purchased) with the exemplary retailer. In one exemplary embodiment, an exemplary retailer would agree to a CPM, CPC or revenue share (as defined above) in order to promote selected Posts.

As will be understood by someone with ordinary skill in the art, there are many ways in which the exemplary platform would be able to filter advertisement targeting such as through geo-location, User demographics, social graph connections (such as, for example, friends on Facebook™ or fans on the exemplary platform), interaction through the exemplary platform (such as, for example, interaction using the exemplary platform's feed), purchases driven or based upon interaction with previous ads.

In one exemplary embodiment, an exemplary marketplace would be used to connect Influencers with Advertiser advertising offers. In one exemplary embodiment, an exemplary marketer would make available (such as, for example, in an exemplary marketplace) an advertisement with a CPC or cost per engagement offer for sharing the advertisement. In one exemplary embodiment, an Influencer would be able to view available advertisements, select and share an advertisement (or in some cases multiple advertisements), and receive payment based upon tracked User engagement through the present invention. In one exemplary embodiment, an exemplary advertising marketplace would provide Users an opportunity to share an advertisement (or advertisements) outside of the exemplary platform (such as, for example, on other social network sites such as Facebook™ or Instagram™). In one exemplary embodiment, an exemplary advertising marketplace would be programmatically run (such as, for example, automatically run and managed by the exemplary platform based upon algorithms operably installed on a User device or algorithms operably installed in the exemplary platform's computer accessible memory in order to manage an exemplary advertising marketplace). In one exemplary embodiment, an exemplary advertisement marketplace would be self-serve. In one exemplary embodiment, an exemplary advertisement marketplace would be referred to as a Performance Influencer Marketplace.

In one such self-serve exemplary embodiment of the present invention, within the exemplary advertising marketplace, marketers would identify Influencers—and an Influencer's followers—based upon certain targeting (such as, for example, by filtering) criteria (such as, for example, demographics, psychographics, geolocation, and/or behavioral data). As will be understood by someone with ordinary skill in the art, reference herein to exemplary targeting criteria is illustrative and is not a limitation of the present invention. Rather in some exemplary embodiments, targeting criteria would include Follower Users' tracked purchase behavior or details regarding tracked Influencer-Influenced-Fan-Purchases.

In one exemplary embodiment, an exemplary advertising marketplace would allow advertisers to upload their own audience data in order to execute precisely targeted advertising (such as, for example, retargeting and look-alike modeling). In one such exemplary embodiment, the output of exemplary targeting capabilities would include the ability to deliver a different advertisement to followers that meet specific targeting criteria both through the exemplary platform as well as through outside social networking platforms (such as, for example, an advertiser would deliver a different advertisement creative to a female follower of an Influencer as compared to a male follower of an Influencer both through exemplary Influencer Commerce platform as well as through other social networking platforms, including Facebook™ and Instagram™). As will be understood by someone with ordinary skill in the art, an exemplary advertising marketplace would be able to make custom advertisements available through outside social network platforms by communicating directly with outside platforms (such as, for example, through Facebook™ Ads).

### Exemplary Platform Revenue Models

As will be understood by someone with ordinary skill in the art, an exemplary platform in the present invention would be facilitating and tracking payment transactions (such as, for example, on behalf of Influencers, Fans and Retailers). Therefore, in some exemplary embodiments, the exemplary platform would generate revenue through use of the exemplary platform. As will be understood by someone with ordinary skill in the art, in some exemplary embodiments, the above summarized revenue generating opportunities in the present application for the present invention (such as, for example, a CPM, CPC or revenue share) would also be used by an exemplary platform to generate revenue. In one exemplary embodiment, the exemplary platform would charge an exemplary retailer based upon the number of Influencer-Influenced-Fan-Purchases that have been tracked by the exemplary platform. In some embodiments, the exemplary platform would charge an exemplary Influencer a revenue share based upon the revenue exemplary Influencer has earned through the exemplary platform (such as, for example, through revenue earned by Influencer through an exemplary marketer based upon tracked Influencer-Influenced-Fan-Purchases).

### Online Discount Conversion Engine

Currently, omni-channel retailers—meaning those who sell across multiple sales channels, including online and in-store—issue online coupons in order to increase online consumer purchases. While online coupons can effectively drive online sales growth, many online coupons cannot be redeemed in-store. Many online coupons require a customer key in (such as, for example, by using the keyboard on an Apple™ Macbook Pro) a code which is applied to the purchase total in order to apply a discount back to the consumer.

Retailers invest financially to generate and accept online coupons, but many online coupons are not redeemable in-store due to technical differences. Some way is needed for retailers to easily convert online coupons into a format that can be accepted in-store. Some exemplary embodiments of the present invention would provide retailers with a conversion engine used to convert online coupons into a format that can be accepted in-store without requiring computer software changes in-store for retailers.

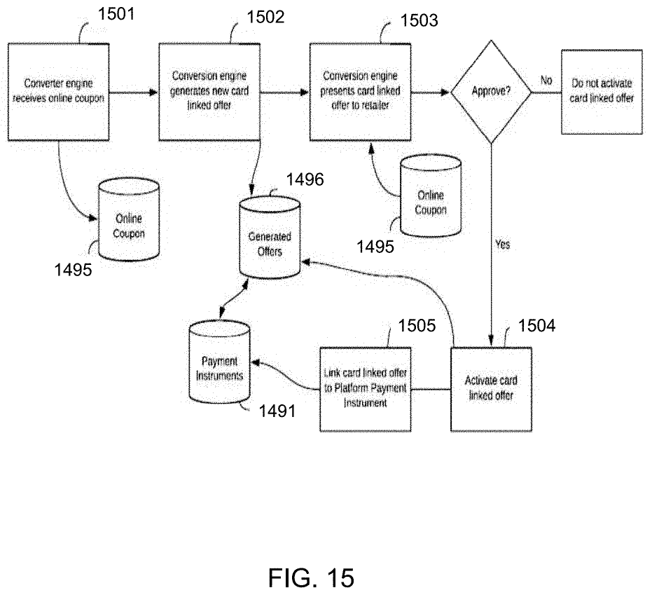

FIG. 15 depicts high-level logic functions for the conversion of an online coupon to an in-store redeemable discount using the present invention. As depicted in function 1501, in one exemplary embodiment, the exemplary conversion engine would receive online coupon details (such as, for example, coupon code, discount amount, or coupon terms of use). Reference herein to coupon details is illustrative and is not a limitation of the present invention. Rather, in some exemplary embodiments, coupon details may include specifics regarding coupon design, locations where coupon can be redeemed and date/time specifics during which coupon can be redeemed.

Continuing in reference to FIG. 15, as depicted in function 1502, in one exemplary embodiment, the exemplary conversion engine would create a new card-linked-offer to match an existing online coupon based upon received coupon details. As will be understood by someone with ordinary skill in the art, the reference herein to a card-linked-offer is illustrative and not a limitation of the present invention. Rather, in some embodiments, an exemplary platform could generate a barcode that when paired with an in-store device provided by an exemplary platform to retailer would facilitate the redemption of an automatically generated in-store discount through the present invention.

Continuing in reference to FIG. 15, as depicted in exemplary function 503, in one exemplary embodiment, the exemplary conversion engine would make an exemplary card-linked-offer available to a retailer responsible for issuing the online coupon in order to receive retailer's approval of new card-linked-offer. As will be understood by someone with ordinary skill in the art, an exemplary conversion engine could make an exemplary card-linked-offer available to retailer using a variety of methods, including through a mobile application or through an Internet connected device. As will be understood by someone with ordinary skill in the art, any connected computer device able to communicate with the exemplary conversion engine whether now known or in the future discovered could be used to access the exemplary card-linked-offers without departing from the spirit of the present invention.

As depicted in exemplary function 1504 in FIG. 15, in one exemplary embodiment, if an exemplary retailer approves an exemplary card-linked-offer, the exemplary platform would activate the generated card linked offer. As depicted in exemplary function 505, in one exemplary embodiment the exemplary platform would automatically associate the exemplary card-linked-offer to exemplary Platform Payment Instruments. In some exemplary embodiments, an exemplary retailer may decide to approve a new exemplary in-store offer but restrict the offer to specific Users. In such an embodiment, the present invention would provide retailers the ability to restrict an offer based upon User activity and payment transaction data available through the exemplary platform.

### Usefulness; Advantages

Some exemplary embodiments of the present invention would provide Influencers with a secure, convenient and reliable way of electronically tracking and monetizing Fan purchases. Further, Influencers would not be restricted by brand, retailer or otherwise when determining what payment transactions and purchase behavior to electronically share with Fans.

Further, because exemplary embodiments empower Influencers to electronically share any or all purchase transaction history, exemplary embodiments of the present invention would provide Influencers the ability to be genuine and authentic thereby improving an Influencer's relationship with Fans.

In addition, exemplary embodiments of the present invention provide retailers and brands the ability reach Influencers' Fans in order to drive purchase transaction volume and electronically track Fan interaction with Influencers and Fan purchase transactions. By combining retailer-backed discounts and promotions with Influencer-shared payment transaction data, retailers are able to greatly benefit from improved customer awareness and increased sales.

Further, because exemplary embodiments of the present invention would automatically track Fan interaction and content views through a platform feed, retailers are able to improve marketing spend efficiency by only providing a discount following an electronically tracked and confirmed consummated Fan purchase. Instead of wasting marketing spend by not being able to properly track customer purchases, exemplary embodiments of the present invention would provide retailers with what is needed to track thoughtful marketing investments based upon Influencer Posts and Fan payment transaction data.

In addition, because exemplary embodiments of the present invention would automatically track User purchase behavior, consumers will be able to trust the shared Posts and use the transaction activity from other consumers when making an educated decision concerning whether or not to purchase a product or service without having to worry about whether or not a recommendation is fraudulent.

In addition, exemplary embodiments of the present invention provide retailers and brands the ability to convert already issued online coupons into in-store redeemable discounts without requiring additional cost to retailers. In turn, by providing additional discounts and incentives to customers, retailers can increase in-store sales without investing time and money into issuing new in-store specific discounts and/or changing in-store technology to accept already-issued online discounts/coupons.

### Other Alternate Embodiments and Implementations

Examples have been described of processes and techniques may be implemented as computer program instructions in a platform service or as provided a service within a social media network. It will be understood that the computer program instructions may be stored on a non-transitory storage medium and executed by processors, such as a processor associated with a network server or server associated with a cloud-based service or network-based service.

In the above description, for purposes of explanation, numerous specific details are set forth in order to provide a thorough understanding of the specification. It will be apparent, however, to one skilled in the art that the invention can be practiced without these specific details. In other instances, structures and devices are shown in block diagram form in order to avoid obscuring the description. For example, the present invention is described in one implementation below primarily with reference to user interfaces and particular hardware. However, the present invention applies to any type of computing system that can receive data and commands, and present information as part of a mobile device.

Reference in the specification to “one implementation” or “an implementation” means that a particular feature, structure, or characteristic described in connection with the implementation is included in at least one implementation of the description. The appearances of the phrase “in one implementation” in various places in the specification are not necessarily all referring to the same implementation.

Some portions of the detailed descriptions described above are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared and otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The present specification also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CD ROMs, and magnetic disks, read-only memories (ROMs), random access memories (RAMs), EPROMs, EEPROMs, magnetic or optical cards, flash memories including USB keys with non-volatile memory or any type of media suitable for storing electronic instructions, each coupled to a computer system bus.

The specification can take the form of an entirely hardware implementation, an entirely software implementation or an implementation containing both hardware and software elements. In one implementation, the specification is implemented in software, which includes but is not limited to firmware, resident software, microcode, etc.

Furthermore, the description can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modems and Ethernet cards are just a few of the currently available types of network adapters.

Finally, the algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the specification is not described with reference to any particular programming language. It will be appreciated that a variety of programming languages may be used to implement the teachings of the specification as described herein.

The foregoing description of the implementations of the present invention has been presented for the purposes of illustration and description. It is not intended to be exhaustive or to limit the present implementation of invention to the precise form disclosed. Many modifications and variations are possible in light of the above teaching. It is intended that the scope of the present implementation of invention be limited not by this detailed description, but rather by the claims of this application. As will be understood by those familiar with the art, the present implementation of invention may be embodied in other specific forms without departing from the spirit or essential characteristics thereof. Likewise, the particular naming and division of the modules, routines, features, attributes, methodologies and other aspects are not mandatory or significant, and the mechanisms that implement the present implementation of invention or its features may have different names, divisions and/or formats. Furthermore, as will be apparent to one of ordinary skill in the relevant art, the modules, routines, features, attributes, methodologies and other aspects of the present implementation of invention can be implemented as software, hardware, firmware or any combination of the three. Also, wherever a component, an example of which is a module, of the present implementation of invention is implemented as software, the component can be implemented as a standalone program, as part of a larger program, as a plurality of separate programs, as a statically or dynamically linked library, as a kernel loadable module, as a device driver, and/or in every and any other way known now or in the future to those of ordinary skill in the art of computer programming. Additionally, the present implementation of invention is in no way limited to implementation in any specific programming language, or for any specific operating system or environment. Accordingly, the specification of the present implementation of invention is intended to be illustrative, but not limiting, of the scope of the present implementation of invention, which is set forth in the following claims.

What is claimed is:

1. A method of providing an augmented service to a social network having at least one user acting as an influencer having one or more fans, comprising:
tracking payment transactions of the influencer;
identifying an entity associated with a payment transaction made by the influencer;
recommending, to the influencer, a posting of content on a social media channel of the influencer associated with at least one attribute of the payment transaction; and
tracking payment transactions of at least one fan in response to the posting of content.

2. The method of claim 1, further comprising confirming a payment transaction of a fan to the entity was made in response to the posting of content by the influencer.

3. The method of claim 2, further comprising providing a financial or non-financial reward to the influencer for a confirmation of a payment transaction of a fan made in response to the posting of content by the influencer.

4. The method of claim 1, wherein tracking payment transactions of the influencer comprises identifying payment transactions made by the influencer via a payment instrument registered to the influencer.

5. The method of claim 1, wherein the tracking payment transactions of the influencer comprises identifying transactions made by the influencer via content posted by the influencer.

6. The method of claim 1, further comprising receiving an incentive offer from the entity and providing the incentive offer to the fan.

7. The method of claim 1, further comprising generating an influence score based at least in part on payment transactions of at least one fan influence by content on a social media channel of the influencer.

8. The method of claim 1, wherein the recommending comprises providing payment transaction information to the influencer, receiving a selection by the influencer of at least one promotion based on the payment transaction, and prompting the influencer to post content to the promotion.

9. The method of claim 1, wherein the at least one promotion comprises a promotion of a good or service associated with the payment transaction.

10. The method of claim 8, further comprising implementing a security protocol to delay the posting or obfuscate confidential information in the post.

11. The method of claim 1, wherein tracking payment transactions of at least one fan comprises identifying transactions made by the fan via a payment instrument registered to the fan.

12. A method of providing an augmented service to a social network having at least one user acting as an influencer having one or more fans, comprising:
receiving profile information of the influencer and issuing a payment instrument to the influencer;
receiving profile information of each fan and issuing each fan a respective unique payment instrument;
tracking payment transactions of the influencer for goods or services;
identifying an entity associated with a payment transaction made by the influencer;
recommending, to the influencer, a posting of content on a social media channel of the influencer for a good or service associated with the payment transaction made by the influencer;
monitoring content posted by the influencer; and
tracking payment transactions of at least one fan in response to the posting of content of the influencer.

13. The method of claim 12, further comprising generating an influence score for the influencer based at least in part on payment transactions of fans made in response to the posting of content of the influencer.

14. The method of claim 12, further comprising verifying an identity of the influencer by biometric scanning.

15. The method of claim 12, further comprising providing a financial or non-financial reward to the influencer for a confirmation of a payment transaction of a fan made in response to the posting of content by the influencer.

16. The method of claim 12, wherein the recommending comprises providing payment transaction information to the influencer, receiving a selection by the influencer of at least one promotion based on the payment transaction, and prompting the influencer to post content to the promotion.

17. The method of claim 12, further comprising implementing a security protocol to delay the posting or obfuscate confidential information in the post.

18. A method of providing an augmented service to a social network having at least one user acting as an influencer having one or more fans, comprising:
identifying payment transactions of the influencer for goods or services;
determining an entity associated with a payment transaction made by the influencer;
suggesting content to be posted on the behalf of the influencer on the social network for a good or service associated with the payment transaction made by the influencer;
monitoring content posted by the influencer;
tracking payment transactions of at least one fan in response to the posting of content of the influencer; and
generating an influence score for the influencer based at least in part on payment transaction of the at least one fan identifying to be made in response to content posted on a social media channel of the influencer.

19. The method of claim 18, wherein the identifying comprising tracking payment transactions of the influencer.

20. The method of claim 18, wherein the identifying comprises inferring payment transactions based on content posted by the influencer.
